(19) United States
(12) Patent Application Publication
(10) Pub. No.: US 2025/0386394 A1
(43) Pub. Date: Dec. 18, 2025

(54) TECHNIQUES FOR CONNECTED MODE DISCONTINUOUS RECEPTION (CDRX) POWER SAVINGS

(71) Applicant: QUALCOMM Incorporated, San Diego, CA (US)

(72) Inventor: Akash KUMAR, Hyderabad (IN)

(21) Appl. No.: 18/741,461

(22) Filed: Jun. 12, 2024

(51) Int. Cl. H04W 76/28; H04L 5/00; H04W 72/1268

(52) U.S. Cl. CPC H04W 76/28; H04L 5/001; H04L 5/0053; H04W 72/1268

(57) ABSTRACT

Methods, systems, and devices for wireless communications are described. A user equipment (UE) may receive a control message that indicates a first a first configuration for multiple connected mode discontinuous reception (CDRX) cycles of the UE. In some cases, the UE may transmit a response message that indicates a preferred configuration for the multiple CDRX cycles or indicates a request to skip one or more first CDRX cycles of the multiple CDRX cycles. As such, the UE may monitor at least a subset of the multiple CDRX cycles in accordance with the response message. In some other cases, the UE may receive, prior to an active duration of a second CDRX cycle of the multiple CDRX cycles, a wake up signal that indicates one or more carriers, of multiple carriers configured for the UE, for which the UE is to monitor for control information within an active duration.

### TECHNICAL FIELD

The following relates to wireless communications, including techniques for connected mode discontinuous reception (CDRX) power savings.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a UE is described. The method may include receiving a control message that indicates a first configuration for a set of multiple CDRX cycles of the UE, transmitting a response message that indicates a preferred configuration for the set of multiple CDRX cycles or indicates a request to skip one or more first CDRX cycles of the set of multiple CDRX cycles, and monitoring at least a subset of the set of multiple CDRX cycles in accordance with the response message.

A UE for wireless communications is described. The UE may include one or more memories storing processor executable code, and one or more processors coupled with the one or more memories. The one or more processors may individually or collectively be operable to execute the code to cause the UE to receive a control message that indicates a first configuration for a set of multiple CDRX cycles of the UE, transmit a response message that indicates a preferred configuration for the set of multiple CDRX cycles or indicates a request to skip one or more first CDRX cycles of the set of multiple CDRX cycles, and monitor at least a subset of the set of multiple CDRX cycles in accordance with the response message.

Another UE for wireless communications is described. The UE may include means for receiving a control message that indicates a first configuration for a set of multiple CDRX cycles of the UE, means for transmitting a response message that indicates a preferred configuration for the set of multiple CDRX cycles or indicates a request to skip one or more first CDRX cycles of the set of multiple CDRX cycles, and means for monitoring at least a subset of the set of multiple CDRX cycles in accordance with the response message.

A non-transitory computer-readable medium storing code for wireless communications is described. The code may include instructions executable by one or more processors to receive a control message that indicates a first configuration for a set of multiple CDRX cycles of the UE, transmit a response message that indicates a preferred configuration for the set of multiple CDRX cycles or indicates a request to skip one or more first CDRX cycles of the set of multiple CDRX cycles, and monitor at least a subset of the set of multiple CDRX cycles in accordance with the response message.

In some examples of the method, UEs, and non-transitory computer-readable medium described herein, transmitting the response message may include operations, features, means, or instructions for transmitting a request message that indicates the preferred configuration for the set of multiple CDRX cycles, and where monitoring at least the subset of the set of multiple CDRX cycles includes and monitoring the set of multiple CDRX cycles in accordance with the preferred configuration based on the request message.

Some examples of the method, UEs, and non-transitory computer-readable medium described herein may further include operations, features, means, or instructions for receiving a second control message that indicates a set of multiple configurations for the set of multiple CDRX cycles, including at least the first configuration and the preferred configuration, and where the request message indicates the preferred configuration from the set of multiple configurations.

In some examples of the method, UEs, and non-transitory computer-readable medium described herein, the first configuration may be associated with a set of values and the request message indicates the preferred configuration via one or more offsets from the set of values.

Some examples of the method, UEs, and non-transitory computer-readable medium described herein may further include operations, features, means, or instructions for receiving an acknowledgment message, responsive to the request message, that indicates the UE may be to apply the preferred configuration, where the set of multiple CDRX cycles may be monitored in accordance with the preferred configuration may be at least in part on the preferred configuration.

Some examples of the method, UEs, and non-transitory computer-readable medium described herein may further include operations, features, means, or instructions for receiving a second control message, responsive to the request message, that indicates a second configuration for the set of multiple CDRX cycles, where the second configuration may be based on the preferred configuration, and where the set of multiple CDRX cycles may be monitored in accordance with the second configuration.

In some examples of the method, UEs, and non-transitory computer-readable medium described herein, transmitting the response message may include operations, features, means, or instructions for transmitting the response message that indicates the request to skip the one or more first CDRX cycles of the set of multiple CDRX cycles, where monitoring at least the subset of the set of multiple CDRX cycles includes and monitoring one or more second CDRX cycles of the set of multiple CDRX cycles, where at least the subset of the set of multiple CDRX cycles includes the one or more second CDRX cycles and does not include the one or more first CDRX cycles.

Some examples of the method, UEs, and non-transitory computer-readable medium described herein may further include operations, features, means, or instructions for skipping monitoring of the one or more first CDRX cycles of the set of multiple CDRX cycles based on transmitting the response message.

Some examples of the method, UEs, and non-transitory computer-readable medium described herein may further include operations, features, means, or instructions for receiving an acknowledgment message, responsive to the response message, that indicates the UE may be to skip the one or more first CDRX cycles of the set of multiple CDRX cycles, where the one or more second CDRX cycles of the set of multiple CDRX cycles may be monitored based on the acknowledgment message.

In some examples of the method, UEs, and non-transitory computer-readable medium described herein, transmitting the response message may include operations, features, means, or instructions for transmitting the response message that indicates the UE may be to skip monitoring for one or more first uplink control grants, one or more first downlink grants, or both, within the one or more first CDRX cycles, where monitoring at least the subset of the set of multiple CDRX cycles includes and monitoring for second uplink grants, second downlink grants, or both, within one or more second CDRX cycles based on the response message, where at least the subset of the set of multiple CDRX cycles includes the one or more second CDRX cycles and does not include the one or more first CDRX cycles.

Some examples of the method, UEs, and non-transitory computer-readable medium described herein may further include operations, features, means, or instructions for skipping monitoring for the one or more first uplink control grants, the one or more first downlink grants, or both, within the one or more first CDRX cycles based on the response message.

Some examples of the method, UEs, and non-transitory computer-readable medium described herein may further include operations, features, means, or instructions for receiving an acknowledgment message, responsive to the response message, that indicates the UE may be to skip monitoring for the one or more first uplink control grants, the one or more first downlink grants, or both, within the one or more first CDRX cycles, where skipping monitoring for the one or more first uplink control grants, the one or more first downlink grants, or both, may be based on receiving the acknowledgment message.

In some examples of the method, UEs, and non-transitory computer-readable medium described herein, the response message indicates the UE may be to skip monitoring of monitoring for the one or more first uplink control grants, the one or more first downlink grants, or both, within the one or more first CDRX cycles across one or more component carriers of a set of multiple component carriers configured for the UE.

In some examples of the method, UEs, and non-transitory computer-readable medium described herein, the response message may be a MAC-CE message or a DCI message.

A method for wireless communications by a network entity is described. The method may include transmitting a control message that indicates a first configuration for a set of multiple CDRX cycles of a UE, receiving a response message that indicates a preferred configuration of the UE for the set of multiple CDRX cycles or indicates a request for the UE to skip one or more first CDRX cycles of the set of multiple CDRX cycles, and transmitting one or more messages within at least a subset of the set of multiple CDRX cycles in accordance with the response message.

A network entity for wireless communications is described. The network entity may include one or more memories storing processor executable code, and one or more processors coupled with the one or more memories. The one or more processors may individually or collectively be operable to execute the code to cause the network entity to transmit a control message that indicates a first configuration for a set of multiple CDRX cycles of a UE, receive a response message that indicates a preferred configuration of the UE for the set of multiple CDRX cycles or indicates a request for the UE to skip one or more first CDRX cycles of the set of multiple CDRX cycles, and transmit one or more messages within at least a subset of the set of multiple CDRX cycles in accordance with the response message.

Another network entity for wireless communications is described. The network entity may include means for transmitting a control message that indicates a first configuration for a set of multiple CDRX cycles of a UE, means for receiving a response message that indicates a preferred configuration of the UE for the set of multiple CDRX cycles or indicates a request for the UE to skip one or more first CDRX cycles of the set of multiple CDRX cycles, and means for transmitting one or more messages within at least a subset of the set of multiple CDRX cycles in accordance with the response message.

A non-transitory computer-readable medium storing code for wireless communications is described. The code may include instructions executable by one or more processors to transmit a control message that indicates a first configuration for a set of multiple CDRX cycles of a UE, receive a response message that indicates a preferred configuration of the UE for the set of multiple CDRX cycles or indicates a request for the UE to skip one or more first CDRX cycles of the set of multiple CDRX cycles, and transmit one or more messages within at least a subset of the set of multiple CDRX cycles in accordance with the response message.

In some examples of the method, network entities, and non-transitory computer-readable medium described herein, receiving the response message may include operations, features, means, or instructions for receiving a request message that indicates the preferred configuration for the set of multiple CDRX cycles, where transmitting the one or more messages within at least the subset of the set of multiple CDRX cycles includes and transmitting the one or more messages within the set of multiple CDRX cycles in accordance with the preferred configuration based on the request message.

Some examples of the method, network entities, and non-transitory computer-readable medium described herein may further include operations, features, means, or instructions for transmitting a second control message that indicates a set of multiple configurations for the set of multiple CDRX cycles, including at least the first configuration and the preferred configuration, and where the request message indicates the preferred configuration from the set of multiple configurations.

In some examples of the method, network entities, and non-transitory computer-readable medium described herein, the first configuration may be associated with a set of values and the request message indicates the preferred configuration via one or more offsets from the set of values.

Some examples of the method, network entities, and non-transitory computer-readable medium described herein may further include operations, features, means, or instructions for transmitting an acknowledgment message, responsive to the request message, that indicates the UE may be to apply the preferred configuration, where the set of multiple CDRX cycles may be monitored in accordance with the preferred configuration.

Some examples of the method, network entities, and non-transitory computer-readable medium described herein may further include operations, features, means, or instructions for transmitting a second control message, responsive to the request message, that indicates a second configuration for the set of multiple CDRX cycles, where the second configuration may be based on the preferred configuration, and where the set of multiple CDRX cycles may be monitored in accordance with the second configuration.

In some examples of the method, network entities, and non-transitory computer-readable medium described herein, receiving the response message may include operations, features, means, or instructions for receiving the response message that indicates the request to skip the one or more first CDRX cycles of the set of multiple CDRX cycles, where transmitting the one or more messages within at least the subset of the set of multiple CDRX cycles includes and transmitting the one or more messages within one or more second CDRX cycles of the set of multiple CDRX cycles based on the response message, where at least the subset of the set of multiple CDRX cycles includes the one or more second CDRX cycles and does not include the one or more first CDRX cycles.

Some examples of the method, network entities, and non-transitory computer-readable medium described herein may further include operations, features, means, or instructions for transmitting an acknowledgment message, responsive to the response message, that indicates the UE may be to skip the one or more first CDRX cycles of the set of multiple CDRX cycles, where the one or more messages may be transmitted within one or more second CDRX cycles of the set of multiple CDRX cycles based on transmitting the acknowledgment message.

In some examples of the method, network entities, and non-transitory computer-readable medium described herein, receiving the response message may include operations, features, means, or instructions for receiving the response message that indicates the UE may be to skip monitoring for one or more first uplink control grants, one or more first downlink grants, or both, within the one or more first CDRX cycles, where transmitting the one or more messages within at least the subset of the set of multiple CDRX cycles includes and transmitting one or more second uplink grants, one or more second downlink grants, or both, within one or more second CDRX cycles based on the response message, where at least the subset of the set of multiple CDRX cycles includes the one or more second CDRX cycles and does not include the one or more first CDRX cycles, and where the one or more messages includes the one or more second uplink grants, the one or more second downlink grants, or both.

Some examples of the method, network entities, and non-transitory computer-readable medium described herein may further include operations, features, means, or instructions for transmitting an acknowledgment message, responsive to the response message, that indicates the UE may be to skip monitoring for the one or more first uplink control grants, the one or more first downlink grants, or both, within the one or more first CDRX cycles, where the one or more second uplink grants, the one or more second downlink grants, or both, may be transmitted within one or more second CDRX cycles based on transmitting the acknowledgment message.

In some examples of the method, network entities, and non-transitory computer-readable medium described herein, the response message indicates the UE may be to skip monitoring of monitoring for the one or more first uplink control grants, the one or more first downlink grants, or both, within the one or more first CDRX cycles across one or more component carriers of a set of multiple component carriers configured for the UE.

In some examples of the method, network entities, and non-transitory computer-readable medium described herein, the response message may be a MAC-CE message or a DCI message.

A method for wireless communications by a UE is described. The method may include receiving a control message that indicates a configuration associated with a set of multiple CDRX cycles of the UE, receiving, prior to an active duration of a CDRX cycle of the set of multiple CDRX cycles, a wake up signal that indicates one or more carriers, of a set of multiple carriers configured for the UE, for which the UE is to monitor for control information within the active duration, and monitoring one or more control channels associated with the one or more carriers within the active duration of the CDRX cycle based on the wake up signal.

A UE for wireless communications is described. The UE may include one or more memories storing processor executable code, and one or more processors coupled with the one or more memories. The one or more processors may individually or collectively be operable to execute the code to cause the UE to receive a control message that indicates a configuration associated with a set of multiple CDRX cycles of the UE, receive, prior to an active duration of a CDRX cycle of the set of multiple CDRX cycles, a wake up signal that indicates one or more carriers, of a set of multiple carriers configured for the UE, for which the UE is to monitor for control information within the active duration, and monitor one or more control channels associated with the one or more carriers within the active duration of the CDRX cycle based on the wake up signal.

Another UE for wireless communications is described. The UE may include means for receiving a control message that indicates a configuration associated with a set of multiple CDRX cycles of the UE, means for receiving, prior to an active duration of a CDRX cycle of the set of multiple CDRX cycles, a wake up signal that indicates one or more carriers, of a set of multiple carriers configured for the UE, for which the UE is to monitor for control information within the active duration, and means for monitoring one or more control channels associated with the one or more carriers within the active duration of the CDRX cycle based on the wake up signal.

A non-transitory computer-readable medium storing code for wireless communications is described. The code may include instructions executable by one or more processors to receive a control message that indicates a configuration associated with a set of multiple CDRX cycles of the UE, receive, prior to an active duration of a CDRX cycle of the set of multiple CDRX cycles, a wake up signal that indicates one or more carriers, of a set of multiple carriers configured for the UE, for which the UE is to monitor for control information within the active duration, and monitor one or more control channels associated with the one or more carriers within the active duration of the CDRX cycle based on the wake up signal.

Some examples of the method, UEs, and non-transitory computer-readable medium described herein may further include operations, features, means, or instructions for refraining from monitoring one or more second carriers, of a set of multiple carriers configured for the UE, for control information within the active duration based on the wake up signal indicating the one or more carriers.

In some examples of the method, UEs, and non-transitory computer-readable medium described herein, the wake up signal further indicates that one or more uplink grants, one or more downlink grants, or both, may be to be transmitted within the active duration and the one or more control channels may be monitored for the one or more uplink grants, the one or more downlink grants, or both, based on the wake up signal indicating the one or more uplink grants, the one or more downlink grants, or both, may be to be transmitted.

In some examples of the method, UEs, and non-transitory computer-readable medium described herein, the wake up signal further indicates the one or more uplink grants, the one or more downlink grants, or both, per carrier of the one or more carriers.

In some examples of the method, UEs, and non-transitory computer-readable medium described herein, the wake up signal further indicates a threshold rank to be scheduled within the active duration and monitoring the one or more control channels associated with the one or more carriers within the active duration of the CDRX cycle may be based on the threshold rank.

A method for wireless communications by a network entity is described. The method may include transmitting a control message that indicates a configuration associated with a set of multiple CDRX cycles of a UE, transmitting, prior to an active duration of a CDRX cycle of the set of multiple CDRX cycles, a wake up signal that indicates one or more carriers, of a set of multiple carriers configured for the UE, for which the UE is to monitor for control information within the active duration, and transmitting one or more messages via one or more control channels associated with the one or more carriers within the active duration of the CDRX cycle based on the wake up signal.

A network entity for wireless communications is described. The network entity may include one or more memories storing processor executable code, and one or more processors coupled with the one or more memories. The one or more processors may individually or collectively be operable to execute the code to cause the network entity to transmit a control message that indicates a configuration associated with a set of multiple CDRX cycles of a UE, transmit, prior to an active duration of a CDRX cycle of the set of multiple CDRX cycles, a wake up signal that indicates one or more carriers, of a set of multiple carriers configured for the UE, for which the UE is to monitor for control information within the active duration, and transmit one or more messages via one or more control channels associated with the one or more carriers within the active duration of the CDRX cycle based on the wake up signal.

Another network entity for wireless communications is described. The network entity may include means for transmitting a control message that indicates a configuration associated with a set of multiple CDRX cycles of a UE, means for transmitting, prior to an active duration of a CDRX cycle of the set of multiple CDRX cycles, a wake up signal that indicates one or more carriers, of a set of multiple carriers configured for the UE, for which the UE is to monitor for control information within the active duration, and means for transmitting one or more messages via one or more control channels associated with the one or more carriers within the active duration of the CDRX cycle based on the wake up signal.

A non-transitory computer-readable medium storing code for wireless communications is described. The code may include instructions executable by one or more processors to transmit a control message that indicates a configuration associated with a set of multiple CDRX cycles of a UE, transmit, prior to an active duration of a CDRX cycle of the set of multiple CDRX cycles, a wake up signal that indicates one or more carriers, of a set of multiple carriers configured for the UE, for which the UE is to monitor for control information within the active duration, and transmit one or more messages via one or more control channels associated with the one or more carriers within the active duration of the CDRX cycle based on the wake up signal.

In some examples of the method, network entities, and non-transitory computer-readable medium described herein, the wake up signal further indicates that one or more uplink grants, one or more downlink grants, or both, may be to be transmitted within the active duration and the one or more control channels may be monitored for the one or more uplink grants, the one or more downlink grants, or both, based on the wake up signal indicating the one or more uplink grants, the one or more downlink grants, or both, may be to be transmitted.

In some examples of the method, network entities, and non-transitory computer-readable medium described herein, the wake up signal further indicates the one or more uplink grants, the one or more downlink grants, or both, per carrier of the one or more carriers.

In some examples of the method, network entities, and non-transitory computer-readable medium described herein, the wake up signal further indicates a threshold rank to be scheduled within the active duration and monitoring the one or more control channels associated with the one or more carriers within the active duration of the CDRX cycle may be based on the threshold rank.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for connected mode discontinuous reception (CDRX) power savings in accordance with one or more aspects of the present disclosure.

FIG. 2 shows an example of a wireless communications system that supports techniques for CDRX power savings in accordance with one or more aspects of the present disclosure.

FIG. 3 shows an example of a wireless communications system that supports techniques for CDRX power savings in accordance with one or more aspects of the present disclosure.

FIG. 4 shows an example of a process flow that supports techniques for CDRX power savings in accordance with one or more aspects of the present disclosure.

FIG. 5 shows an example of a process flow that supports techniques for CDRX power savings in accordance with one or more aspects of the present disclosure.

FIGS. 6 and 7 show block diagrams of devices that support techniques for CDRX power savings in accordance with one or more aspects of the present disclosure.

FIG. 8 shows a block diagram of a communications manager that supports techniques for CDRX power savings in accordance with one or more aspects of the present disclosure.

FIG. 9 shows a diagram of a system including a device that supports techniques for CDRX power savings in accordance with one or more aspects of the present disclosure.

FIGS. 10 and 11 show block diagrams of devices that support techniques for CDRX power savings in accordance with one or more aspects of the present disclosure.

FIG. 12 shows a block diagram of a communications manager that supports techniques for CDRX power savings in accordance with one or more aspects of the present disclosure.

FIG. 13 shows a diagram of a system including a device that supports techniques for CDRX power savings in accordance with one or more aspects of the present disclosure.

FIGS. 14 through 17 show flowcharts illustrating methods that support techniques for CDRX power savings in accordance with one or more aspects of the present disclosure.

### DETAILED DESCRIPTION

In some wireless communications systems, a user equipment (UE) may operate according to a connected mode discontinuous reception (CDRX) configuration. That is, the CDRX configuration may define (e.g., configure) periodic cycles, which may be referred to as CDRX cycles, of active durations, in which the UE may wake up to monitor for communications from a network entity (e.g., enter an active mode), and inactive durations, in which the UE may sleep (e.g., enter a sleep or idle mode). However, in some cases, the CDRX configuration may not consider other operations associated with the UE, parameters associated with the UE, or both, such as inactive durations associated with an additional radio access technology (RAT) supported by the UE, a power level of the UE, or the like thereof. As such, the CDRX configuration may not enable the UE to achieve power consumption reductions intended by the CDRX configuration in the absence of the other operations, the parameters, or both.

Additionally, or alternatively, in some cases, a network entity may transmit a wake up signal (WUS) prior to an active duration of a CDRX cycle to indicate to the UE whether one or more transmissions are scheduled within (e.g., during, in) the active duration (e.g., whether the UE needs to wake up), such that if no transmissions are scheduled, the UE may skip waking up within the active duration. However, in some cases, the UE may support carrier aggregation (CA) in which the UE supports multiple component carriers (CCs). In such cases, the UE may wake up and monitor for signaling on all CCs supported by the UE based on receiving a WUS, which may result in unnecessary power consumption if the network entity does not transmit signaling on one or more of the CCs.

Accordingly, techniques described herein may enable a UE to indicate information to a network entity about a preferred (e.g., desired, requested) CDRX configuration, one or more CDRX cycles to be skipped by the UE, or both. For example, the network entity may transmit, to the UE, a first control message indicating a first CDRX configuration and, in some cases, the UE may transmit a response message indicating a preferred CDRX configuration. In some other cases, the UE may transmit the response message indicating one or more upcoming CDRX cycles to be skipped by the UE. In such cases, the UE may indicate that the UE may skip monitoring for uplink grants and downlink grants within the one or more upcoming CDRX cycles or may indicate that the UE may skip monitoring for either uplink grants or downlink grants within the one or more upcoming CDRX cycles.

Additionally, or alternatively, techniques described herein may enable a network entity to transmit a WUS indicating for the UE to wake up to monitor for one or more transmissions on a per-CC basis. For example, the UE may receive, prior to an active duration of a CDRX cycle, a WUS indicating one or more CCs, of multiple CCs configured for the UE, for which the UE is to monitor for control information within the active duration. Thus, the UE may monitor one or more control channels associated with the one or more CCs within the active duration of the CDRX cycle based on the WUS. Additionally, or alternatively, the WUS may indicate a threshold (e.g., maximum) rank to be scheduled within the active duration, whether one or more uplink grants, one or more downlink grants, or both, are to be transmitted within the active duration, or both.

Aspects of the disclosure are initially described in the context of wireless communications systems. Aspects of the disclosure are then described in the context of process flows. Aspects of the disclosure are further illustrated by and described with reference to apparatus diagrams, system diagrams, and flowcharts that relate to techniques for CDRX power savings.

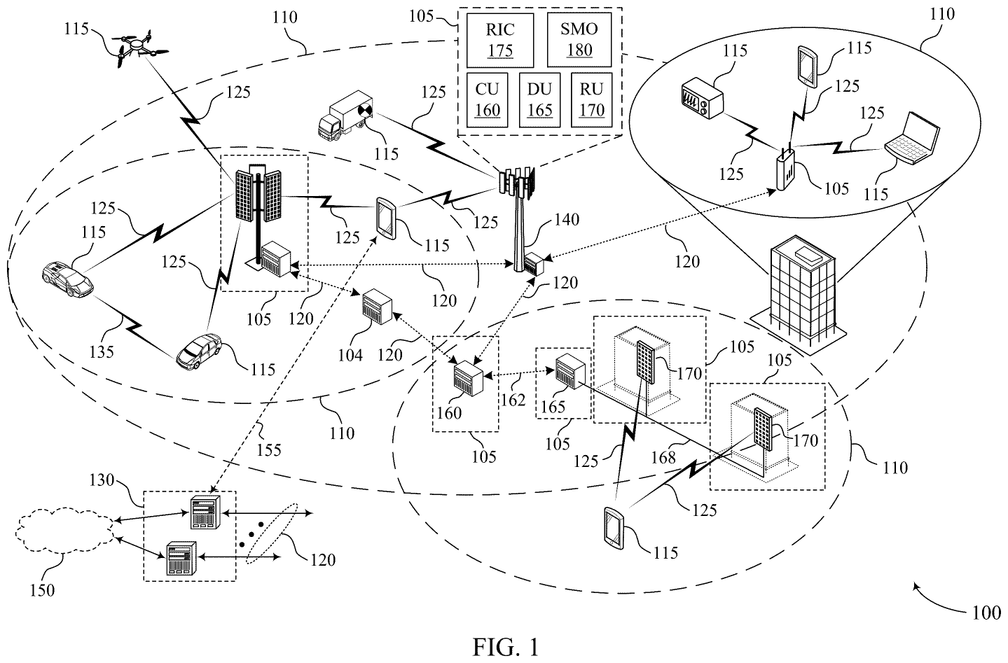

FIG. 1 shows an example of a wireless communications system 100 that supports techniques for CDRX power savings in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, a sixth generation (6G) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a personal computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, a UE 115, a network entity 105, or both, of the wireless communications system 100 may support techniques to indicate information to a network entity 105 about a preferred CDRX configuration, one or more CDRX cycles to be skipped by the UE 115, or both. For example, the network entity 105 may transmit, to the UE 115, a first control message indicating a first CDRX configuration and, in some cases, the UE 115 may transmit a response message indicating a preferred CDRX configuration. In some other cases, the UE 115 may transmit the response message indicating one or more upcoming CDRX cycles to be skipped by the UE 115. In such cases, the UE 115 may indicate that the UE 115 may skip monitoring for uplink grants and downlink grants within the one or more upcoming CDRX cycles or may indicate that the UE 115 may skip monitoring for either uplink grants or downlink grants within the one or more upcoming CDRX cycles.

Additionally, or alternatively, the UE 115, the network entity 105, or both, of the wireless communications system 100 may support techniques to enable the network entity 105 to transmit a WUS indicating for the UE 115 to wake up to monitor for one or more transmissions on a per-CC basis. For example, the UE 115 may receive, prior to an active duration of a CDRX cycle, a WUS indicating one or more CCs, of multiple CCs configured for the UE 115, for which the UE 115 is to monitor for control information within the active duration. Thus, the UE 115 may monitor one or more control channels associated with the one or more CCs within the active duration of the CDRX cycle based on the WUS. Additionally, or alternatively, the WUS may indicate a threshold (e.g., maximum) rank to be scheduled within the active duration, whether one or more uplink grants, one or more downlink grants, or both, are to be transmitted within the active duration, or both.

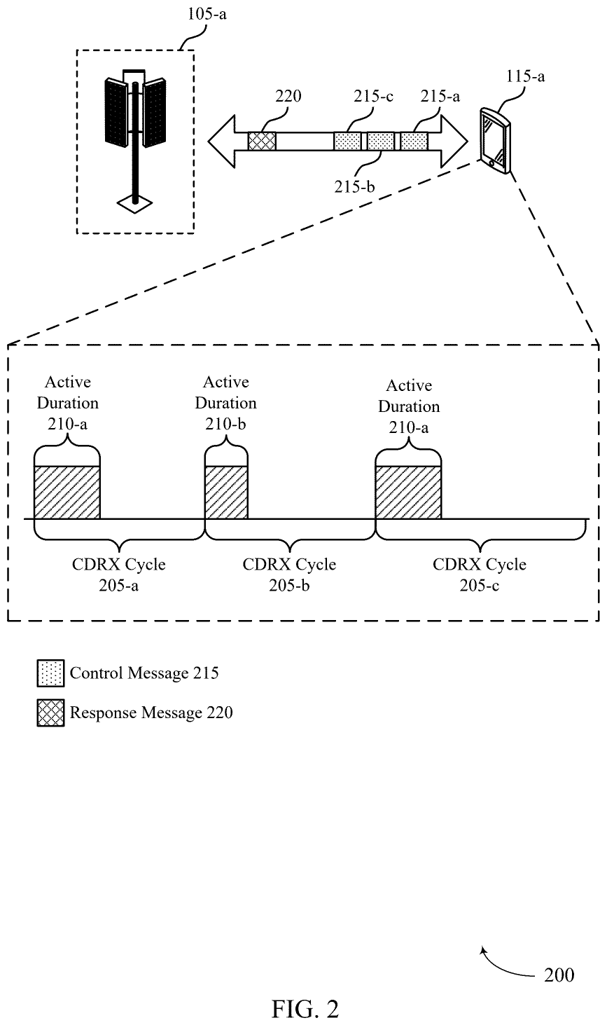

FIG. 2 shows an example of a wireless communications system 200 that supports techniques for CDRX power savings in accordance with one or more aspects of the present disclosure. In some cases, the wireless communications system 200 may implement or be implemented by aspects of the wireless communications system 100. For example, the wireless communications system 200 may include one or more UEs 115 (e.g., a UE 115-a) and one or more network entities 105 (e.g., a network entity 105-a), which may be examples of the corresponding devices as described herein.

In some wireless communications systems, such as the wireless communications system 200, a UE 115, such as the UE 115-a, may operate according to a CDRX configuration. That is, the CDRX configuration (e.g., CDRX configuration information) may define (e.g., configured) periodic cycles, which may be referred to as CDRX cycles 205, of active durations 210 (e.g., on durations) and inactive durations (e.g., off durations or lower power consumption durations relative to the active durations). Within the active durations 210, the UE 115-a may wake up (e.g., enter an active mode, a connected mode, or a physical downlink control channel (PDCCH) monitoring mode) to monitor for communications from the network entity 105-a and, within the inactive durations, the UE 115-a may sleep (e.g., enter an inactive mode, an idle mode, or a sleep mode). Operating according to a CDRX configuration may enable the UE 115-a to save power (e.g., energy) by sleeping within the inactive durations.

In some examples, the UE 115-a may support (e.g., employ) additional power saving techniques in conjunction with the operations according to the CDRX configuration (e.g., given that the UE 115-a stays in the PDCCH monitoring mode for a threshold amount of time in a CDRX cycle 205). For example, the UE 115-a may shut down some devices or functions (e.g., software defined radio (SDR), power amplifier (PA), low noise amplifier (LNA)) within the inactive duration (e.g., within sleep), where the devices or functions may be associated with a threshold power consumption (e.g., may be the most power consuming devices of the UE 115-a). Additionally, or alternatively, the UE 115-a may enter a “quick sleep” if the UE 115-a fails to detect a grant after decoding a PDCCH (e.g., microsleep).

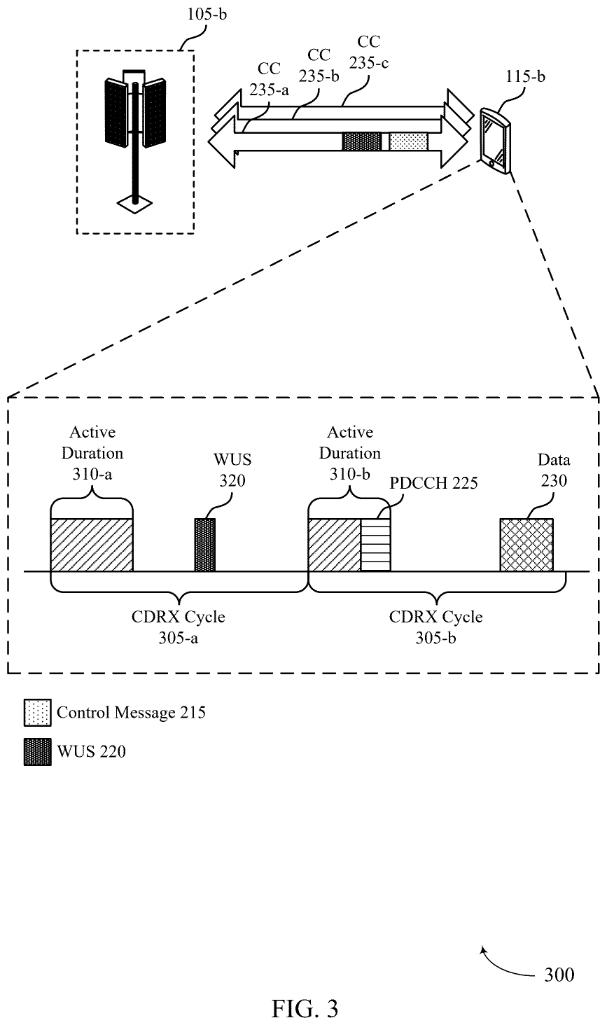

Additionally, or alternatively, the network entity 105-a may support additional power saving techniques to enable the UE 115-a to further reduce power consumption while operating according to the CDRX configuration. For example, the network entity 105-a may transmit a WUS (e.g., downlink control information (DCI)) prior to an active duration 210 of a CDRX cycle 205 (e.g., before CDRX wake up) indicating if the UE 115-a is to (e.g., should) wake up for the upcoming active duration 210, as described further with reference to FIG. 3. Additionally, or alternatively, the network entity 105-a may transmit a secondary cell (SCell) dormancy indication indicating for the UE 115-a to switch an SCell (e.g., supported by the UE 115-a) to a dormant bandwidth part (BWP) within or outside of an active duration 210 (e.g., active time) to stop PDCCH monitoring for the SCell. Additionally, or alternatively, the network entity 105-a may transmit a control message 215 (e.g., skipping indication) indicating for the UE 115-a to skip one or more active durations 210 (e.g., PDCCH monitoring occasions).

However, in some cases, the CDRX configuration, the additional power saving techniques (e.g., particularly those initiated by the network entity 105-a), or both, may not consider any combination of other operations associated with the UE 115-a, parameters associated with the UE 115-a, a status of the UE 115-a, a mode of the UE 115-a, or the like thereof. For example, the UE 115-a may support multiple RATs, where each RAT is associated with a different CDRX configuration, however, inactive durations associated with the different CDRX configurations may not align, such that the UE 115-a may not be able to take full advantage of the inactive durations (e.g., may not be able to fully sleep). Additionally, or alternatively, a power level of the UE 115-a may be below a threshold but a frequency of active durations 210 associated with a CDRX configuration may be frequent (e.g., above a threshold), such that the UE 115-a may lose power more quickly (e.g., as compared to less frequent active durations 210). As such, a CDRX configuration supported by the UE 115-a may not enable the UE 115-a to achieve power consumption reductions intended by the CDRX configuration in the absence of other UE-specific considerations.

Accordingly, techniques described herein may enable the UE 115-a to indicate information to the network entity 105-a about a preferred CDRX configuration, one or more CDRX cycles 205 to be skipped by the UE 115-a, or both (e.g., to enable the UE 115-a to assist or negotiate CDRX operations with the network entity 105-a). A preferred CDRX configuration may be a CDRX configuration requested by the UE 115-a (e.g., requested CDRX configuration) that is at least partially different from a CDRX configuration currently configured for the UE 115-a (e.g., a current CDRX configuration). In some cases, the current CDRX configuration may be a CDRX configuration indicated by the network entity 105-a (e.g., a first CDRX configuration) or may be a previous preferred CDRX configuration requested by the UE 115-a. Additionally, or alternatively, the preferred CDRX configuration (e.g., and a difference between the preferred CDRX configuration and the current CDRX configuration) may be based on any combination of the other operations associated with the UE 115 a, the parameters associated with the UE 115 a, the status of the UE 115 a, the mode of the UE 115 a, or the like thereof (e.g., UE-specific considerations, a change in UE-specific considerations). For example, a preferred CDRX configuration may be based on (e.g., may be determined by the UE 115-a such that) aligning (e.g., at least partially aligning) active durations 210, inactive durations, or both, of different CDRX cycles 205 associated with one or more RATs associated with the UE 115-a (e.g., that are currently operating).For example, in some cases, the UE 115-a may receive a control message 215-b indicating the first CDRX configuration for the UE 115-a for multiple CDRX cycles 205 of the UE 115-a. Additionally, the UE 115-a may transmit, to the network entity 105-a (e.g., before a first CDRX cycle 205, while operating according to the first CDRX configuration, etc.), a response message 220 (e.g., medium access control-control element (MAC-CE), request message) indicating a preferred CDRX configuration of the UE 115-a. In such cases, the preferred CDRX configuration may consider one or more UE-specific considerations. For example, as described previously, the UE 115-a may support multiple RATs and may consider other RAT (e.g., or subscription) activity for determination of the preferred CDRX configuration to align inactive durations across multiple the multiple RATs to improve power savings, mitigate inter-RAT interference (e.g., co-existence), or both. Additionally, or alternatively, the UE 115-a may consider other application-related parameters, such as low battery, lesser current, upcoming activity (e.g., real time activity on the device) for determination of the preferred CDRX configuration to improve power savings.

In some cases, the UE 115-a may indicate the preferred CDRX configuration from a set of CDRX configurations (e.g., including the first CDRX configuration). For example, the network entity 105-a may transmit (e.g., prior to the control message 215-b), a control message 215-a indicating the set of CDRX configurations, such that the response message 220 may indicate the preferred CDRX configuration from the set of CDRX configurations. As an illustrative example, the first CDRX configuration (e.g., from the set of CDRX configurations) may be associated with a CDRX cycle 205-a including an active duration 210-a, where the CDRX cycle 205-a is associated with a first duration. However, the UE 115-a may determine that a CDRX cycle 205 with a longer duration, such as the CDRX cycle 205-c, may enable the UE 115-a to improve power savings. Thus, the UE 115-a may identify a second CDRX configuration from the set of CDRX configurations, where the second CDRX configuration is associated with the CDRX cycle 205-c (e.g., including an active duration 210-a) which is further associated with a second duration longer than the first duration, As such, the UE 115-c may transmit the response message 220 indicating the second CDRX configuration, from the set of CDRX configurations, as the preferred CDRX configuration.

Additionally, or alternatively, the UE 115-a may indicate the preferred CDRX configuration as one or more offsets from the first CDRX configuration. For example, the first CDRX configuration may be associated with a first set of parameters (e.g., a first set of values), such that the response message 220 may indicate the preferred CDRX configuration as one or more offsets (e.g., positive or negative) from at least one parameter of the first set of parameters. As an illustrative example, the first CDRX configuration may be associated with the CDRX cycle 205-a including the active duration 210-a, where the active duration 210-a is associated with a first length (e.g., duration) indicated by the first CDRX configuration. However, the UE 115-a may determine that a CDRX cycle 205 with a shorter (e.g., in length) active duration 210, such as a CDRX cycle 205-b with an active duration 210-b, may enable the UE 115-a to improve power savings. Thus, the UE 115-a may identify an offset (e.g., negative offset) from the first length and may transmit the response message 220 indicating the offset. In other words, the response message 220 may indicate a difference between the first length associated with active duration 210-a and a second length associated with the active duration 210-b.

Additionally, or alternatively, the UE 115-a may indicate the preferred CDRX configuration as a new CDRX configuration determined by the UE 115-a (e.g., the preferred CDRX configuration is up to UE-implementation). That is, the UE 115-a may determine a preferred CDRX configuration (e.g., without consideration for the set of CDRX configurations, without consideration of the one or more offsets) and may transmit the response message 220 indicating the preferred CDRX configuration. For example, the UE 115-a may determine a set of parameters for the preferred CDRX configuration, such as a preferred length of active durations 210, a preferred duration of CDRX cycles 205, or the like thereof, and may transmit the response message 220 indicating the set of parameters.

In some cases, the UE 115-a may receive a control message 215-c (e.g., a feedback message) in response to the preferred CDRX configuration. In some examples, the control message 215-c (e.g., an acknowledgement message) may include an acknowledgement indicating that the UE 115-a may apply the preferred CDRX configuration. In such case, the UE 115-a may apply the preferred CDRX configuration based on receiving the acknowledgement. Conversely, the control message 215-c (e.g., a negative acknowledgement message) may include a negative acknowledgement indicating that the UE 115-a may not apply the preferred CDRX configuration. In such case, the UE 115-a may refrain from applying the preferred CDRX configuration based on receiving the negative acknowledgement (e.g., and may continue to operate according to the first CDRX configuration)

Additionally, or alternatively, the control message 215-c may indicate a third CDRX configuration (e.g., from the set of CDRX configurations), where the third CDRX configuration is based on the preferred CDRX configuration. In such case, the UE 115-a may apply the third CDRX configuration based on receiving the control message 215-c indicating the third CDRX configuration. In some other examples, the UE 115-a may apply the preferred CDRX configuration based on transmitting the response message 220 (e.g., without receiving the control message 215-c)

Additionally, or alternatively, the UE 115-a may transmit, to the network entity 105-a (e.g., within an active duration 210), a response message 220 (e.g., MAC-CE, request message) indicating a request to skip one or more CDRX cycles 205 (e.g., of the multiple CDRX cycles 205 associated with the first CDRX configuration). That is, the response message 220 may indicate an intent for the UE 115-a to sleep within (e.g., skip) one or more (e.g., ‘N’) upcoming CDRX cycles 205. For example, the UE 115-a may transmit, within the active duration 210-a, the response message 220 indicating an intent (e.g., request) for the UE 115-a to skip (e.g., refrain from waking up, refrain from monitoring) the CDRX cycle 205-b, the CDRX cycle 205-c, or both. In some examples, the indication to skip may be in terms of ‘N’ upcoming CDRX cycles 205. That is, to skip the CDRX cycle 205-b and the CDRX cycle 205-c, the response message 220, transmitted within the active duration 210-a, may request for the UE 115-a to skip the next 2 CDRX cycles (e.g., corresponding to the CDRX cycle 205-b and the CDRX cycle 205-c).

In some cases, the UE 115-a may skip the one or more indicated CDRX cycles 205 based on transmitting the response message 220. In some other cases, the UE 115-a may skip the one or more indicated CDRX cycles 205 based on receiving, in response to the response message 220, a control message 215-c indicating an acknowledgement, where the acknowledgement indicates the UE 115-a is to skip the one or more indicated CDRX cycles 205.

Additionally, or alternatively, the UE 115-a may transmit, to the network entity 105-a (e.g., within an active duration 210), a response message 220 (e.g., MAC-CE, request message) indicating a request to skip monitoring for uplink grants, downlink grants, or both, within one or more CDRX cycles 205 (e.g., of the multiple CDRX cycles 205 associated with the first CDRX configuration). That is, the response message 220 may indicate an intent for the UE 115-a to skip monitoring (e.g., PDCCH monitoring) for uplink grants (e.g., uplink DCIs), downlink grants (e.g., downlink DCIs), or both, within respective active durations 210 of one or more upcoming CDRX cycles 205. For example, the UE 115-a may transmit, within the active duration 210-a, the response message 220 indicating an intent (e.g., request) for the UE 115-a to skip monitoring for downlink grants within the CDRX cycle 205-b. In some examples, the indication to skip monitoring may be across all CCs supported by (e.g., configured for) the UE 115-a or may be across one or more CCs indicated in the response message 220. For example, the UE 115-a may transmit, within the active duration 210-a, the response message 220 indicating an intent for the UE 115-a to skip monitoring for downlink grants within the CDRX cycle 205-b on a first CC, a second CC, or both, of multiple CCs supported by the UE 115-a. Transmitting a response message 220 indicating a request to skip monitoring for uplink grants, downlink grants, or both, within one or more CDRX cycles 205 may enable the UE 115-a to perform power savings based on operations and conditions (e.g., and requirements) of the UE 115-a more efficiently and may enable the UE 115-a to support co-existence of multiple RATs more efficiently based on an ability of the UE 115-a to selectively monitor for uplink grants, downlink grants, or both (e.g., as compared to not transmitting the response message 220).

FIG. 3 shows an example of a wireless communications system 300 that supports techniques for CDRX power savings in accordance with one or more aspects of the present disclosure. In some cases, the wireless communications system 300 may implement or be implemented by aspects of the wireless communications system 100, the wireless communications system 200, or both. For example, the wireless communications system 300 may include one or more UEs 115 (e.g., a UE 115-b) and one or more network entities 105 (e.g., a network entity 105-b), which may be examples of the corresponding devices as described herein.

In some cases, as described previously with reference to FIG. 2, a UE 115, such as the UE 115-b, may operate according to a CDRX configuration. That is, the CDRX configuration (e.g., CDRX configuration information) may define (e.g., configured) periodic cycles, which may be referred to as CDRX cycles 305, of active durations 310 (e.g., on durations) and inactive durations (e.g., off durations). Within the active durations 310, the UE 115-b may wake up to monitor for communications from the network entity 105-b and, within the inactive durations, the UE 115-a may sleep.

Additionally, in some cases, to support additional power savings, the network entity 105-b may transmit a WUS 320 prior to an active duration 310 of a CDRX cycle 305 to indicate to the UE 115-a whether one or more transmissions (e.g., one or more uplink grants, one or more downlink grants, or both) are scheduled within the active duration 310 (e.g., whether the UE 115-b needs to wake up for PDCCH monitoring). As such, if the UE 115-b receives a WUS 320 indicating one or more upcoming transmissions, the UE 115-b may wake up within a corresponding (e.g., upcoming) active duration 310 to monitor for the upcoming transmission and, if the UE 115-b receives a WUS 320 indicating no upcoming transmissions (E.g., or does not receive a WUS 320), the UE 115-b may skip (e.g., refrain from) waking up within the corresponding active duration 310 (e.g., skip PDCCH monitoring).

For example, as depicted in FIG. 3, the UE 115-b may receive a control message 215 indicating a CDRX configuration for the UE 115-b for multiple CDRX cycles 305, including at least CDRX cycle 305-a with an active duration 310-a and a CDRX cycle 305-b with an active duration 310-b. In some cases, the UE 115-b may receive, prior to the active duration 310-b, a WUS 320 indicating an upcoming PDCCH 225 scheduled within the active duration 310-b. As such, the UE 115-b may wake up within the active duration 310-b and monitor for the PDCCH 225. In such cases, the PDCCH 225 may schedule data 230 within the CDRX cycle 305-b, such that if the UE 115-b successfully receives the PDCCH 225, the UE 115-b may further monitor for the data 230 within the CDRX cycle 305-b (e.g., may remain active to receive the data 230).

However, in some cases, the UE 115-b may support CA in which the UE 115-b supports communications via multiple CCs 235, such as a CC 235-a, a CC 235-b, and a CC 235-c. In such cases, after receiving a WUS 320, the UE 115-b may wake up and monitor for one or more transmissions on all of the multiple CCs 235 (e.g., configured for the UE 115-b). However, the network entity 105-b may not transmit the one or more transmissions on all of the multiple CCs 235, resulting in unnecessary power consumption associated with monitoring for the one or more transmissions on CCs 235 on which the network entity 105-b does not transmit the one or more transmissions. For example, continuing with the example described previously, the UE 115-a may receive the WUS 320 and may monitor for the PDCCH 225 on the CC 235-a, the CC 235-b, and the CC 235-c within the on duration 310-b. However, the network entity 105-b may transmit the PDCCH 225 on the CC 235-a (e.g., and not on the CC 235-b and the CC 235-c). Thus, monitoring for the PDCCH 225 on the CC 235-b and the CC 235-c may result in unnecessary power consumption.

Accordingly, techniques described herein may enable the network entity 105-b to transmit a WUS 320 indicating for the UE 115-b to wake up to monitor one or more control channels for one or more transmissions on a per-CC 235 basis (e.g., per-configured carrier basis). That is, the UE 115-b may receive a WUS 320 indicating one or more CCs 235 for which the UE 115-b is to monitor for one or more transmissions (e.g., is to perform PDCCH monitoring). For example, the UE 115-b may receive a WUS 320 prior to the active duration 310-b indicating for the UE 115-b to wake up to monitor one or more first control channels for the PDCCH 225 on the CC 235-a. As such, the UE 115-b may wake up a receiver (e.g., transmitter and/or receiver) associated with the CC 235-a (e.g., expecting a grant) within the active duration 310-b to monitor the one or more first control channels for the PDCCH 225 and may refrain from waking up a receiver (e.g., transmitters and/or receivers associated with the CC 235-b and the CC 235-c (e.g., not expecting a grant) within the active duration 310-b. That is, the UE 115-b may refrain from waking up to monitor one or more second control channels associated with the CC 235-b and the CC 235-c within the active duration 310-b. Refraining from waking up the receivers associated with the CC 235-b and the CC 235-c may reduce (e.g., save) leakage current from the one or more receivers associated with the CC 235-b and the CC 235-c and may reduce a radio frequency (RF) warm up duration.

Additionally, or alternatively, the network entity 105-b may transmit a WUS 320 indicating a threshold (e.g., maximum) rank to be scheduled within (e.g., in) an upcoming active duration 310 (e.g., wakeup cycle). As such, the UE 115-b may wake up to monitor one or more control channels for one or more transmissions scheduled within the upcoming active duration 310 based on the threshold rank to be scheduled. In other words, the UE 115-b may wake up one or more first receivers within the upcoming active duration 310 and may refrain from waking up one or more second receives within the upcoming active duration 310 based on the threshold rank, which may reduce leakage from the one or more second receivers (e.g., and one or more second transmitters), in addition to reducing RF warm up duration.

Additionally, or alternatively, the network entity 105-b may transmit a WUS 320 indicating one or more uplink grants, one or more downlink grants, or both, to be scheduled within an upcoming active duration 310. As such, the UE 115-b may wake up to monitor one or more control channels for the one or more uplink grants, the one or more downlink grants, or both scheduled within the upcoming active duration 310 based on receiving the WUS 320. In some examples, the one or more uplink grants, the one or more downlink grants, or both, may be indicated per CC 235 of the multiple CCs 235. For example, a WUS 320 may indicate that a downlink grant is scheduled on the CC 235-b within the active duration 310-b and an uplink grant is scheduled on the CC 235-c within the active duration 310-b. Thus, the UE 115-b may wake up and monitor for the downlink grant on the CC 235-b within the active duration 310-b and may wake up and monitor for the uplink grant on the CC 235-c within the active duration 310-b.

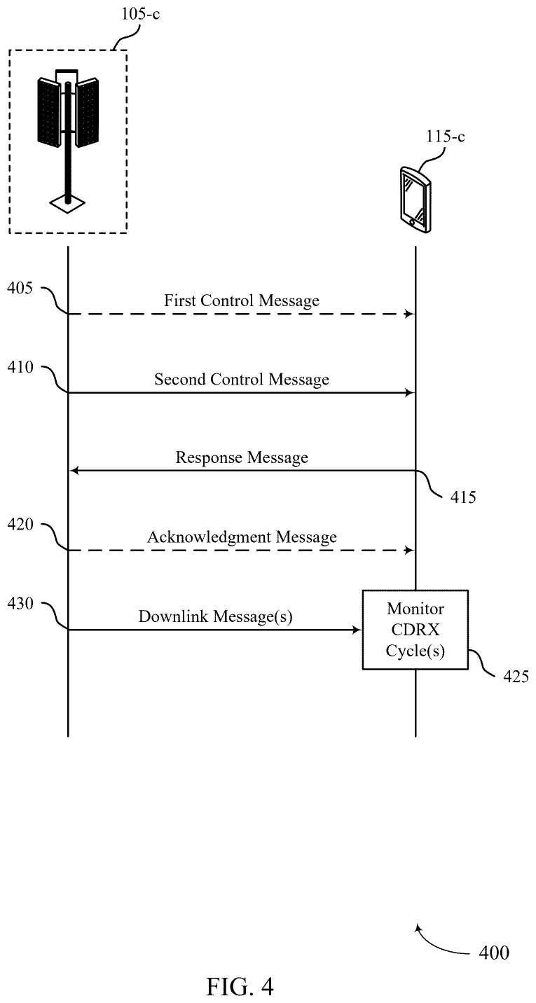

FIG. 4 shows an example of a process flow 400 that supports techniques for CDRX power savings in accordance with one or more aspects of the present disclosure. In some cases, the process flow 400 may implement or be implemented by aspects of the wireless communications system 100, the wireless communications system 200, the wireless communications system 300, or any combination thereof. For example, the process flow 400 may include one or more UEs 115 (e.g., a UE 115-c) and one or more network entities 105 (e.g., a network entity 105-c), which may be examples of the corresponding devices as described herein. In the following description of the process flow 400, the operations between the UE 115-c and the network entity 105-c may be transmitted in a different order than the example order shown, or the operations performed by the UE 115-c and the network entity 105-c may be performed in different orders or at different times. Some operations may also be omitted from the process flow 400, and other operations may be added to the process flow 400.

In some cases, at 405, the UE 115-c may receive, from the network entity 105-c, a first control message indicating a set of multiple configurations for multiple CDRX cycles of the UE 115-c.

In some cases, at 410, the UE 115-c may receive, from the network entity 105-c, a second control message that indicates a first configuration for the multiple CDRX cycles of the UE 115-c (e.g., a first CDRX configuration). In some cases, the first configuration may be from the set of multiple configurations, may be associated with a set of values (e.g., parameters), or both.

In some cases, at 415, the UE 115-c may transmit, to the network entity 105-c, a response message (e.g., MAC-CE message or DCI message) that indicates a preferred configuration (e.g., preferred CDRX configuration) for the multiple CDRX cycles or indicates a request to skip one or more first CDRX cycles of the multiple CDRX cycles. For example, the UE 115-c may transmit the response message (e.g., a request message) that indicates the preferred configuration for the multiple CDRX cycles. In some cases, the preferred configuration may be from the set of multiple configurations. Additionally, or alternatively, the preferred configuration may be indicated (e.g., in the response message) via one or more offsets from the set of values associated with the first configuration.

Additionally, or alternatively, the response message may indicate the request to skip the one or more first CDRX cycles. In some cases, the response message may indicate the request to skip monitoring for one or more uplink grants, one or more downlink grants, or both, within the one or more first CDRX cycle. In some examples, the request to skip monitoring for the one or more uplink grants, the one or more downlink grants, or both, may be across one or more CCs of the multiple CCs (e.g., may be per-CC).

In some cases, at 420, the UE 115-c may receive, from the network entity 105-c, an acknowledgement message (e.g., feedback message) responsive to the response message. For example, in some cases, the acknowledgement message may indicate that the UE 115-c is to apply the preferred configuration. In some other cases, the acknowledgement message may indicate a second configuration (e.g., from the set of multiple configurations) for the multiple CDRX cycles, where the second configuration is based on the preferred configuration. Additionally, or alternatively, the acknowledgement message may indicate that the UE 115-c is to skip the one or more first CDRX cycles. In some cases, the acknowledgement message may indicate that the UE 115-c is to skip monitoring for the one or more uplink grants, the one or more downlink grants, or both, within the one or more first CDRX cycles.

In some cases, at 425, the UE 115-c may monitor at least subset of the multiple CDRX cycles based on the response message (e.g., and based on the acknowledgement message). For example, in some cases, the UE 115-c may monitor the multiple CDRX cycles in accordance with the preferred configuration. In some other cases, the UE 115-c may monitor the multiple CDRX cycles in accordance with the second configuration. Additionally, or alternatively, the UE 115-c may monitor one or more second CDRX cycles of the multiple CDRX cycles, where the one or more second CDRX cycles do not include the one or more first CDRX cycles. In other words, the UE 115-c may skip monitoring of the one or more first CDRX cycles based on transmitting the response message indicating the request to skip the one or more first CDRX cycles.

In some cases, at 430, the UE 115-c may receive, from the network entity 105-c, one or more downlink messages within at least the subset of the multiple CDRX cycles based on the response message.

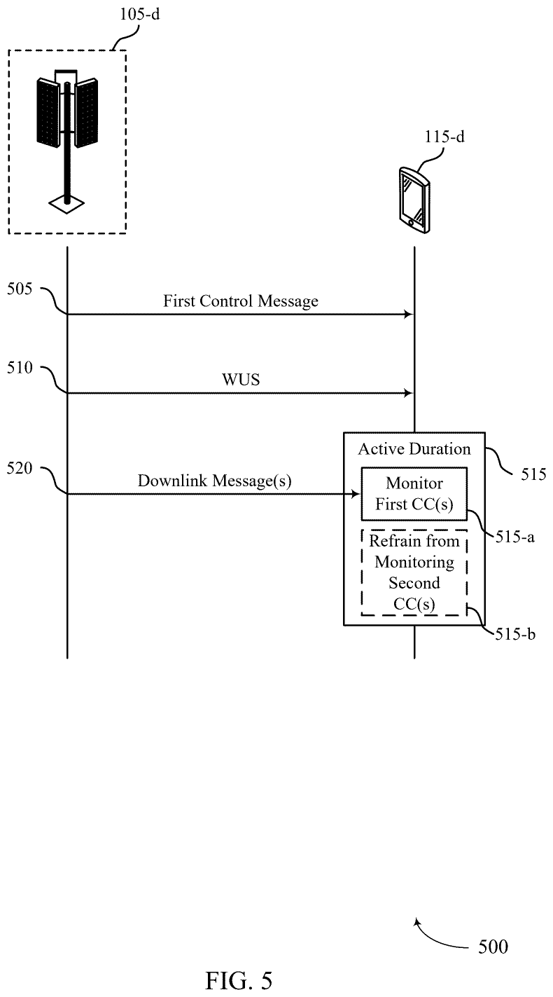

FIG. 5 shows an example of a process flow 500 that supports techniques for CDRX power savings in accordance with one or more aspects of the present disclosure. In some cases, the process flow 500 may implement or be implemented by aspects of the wireless communications system 100, the wireless communications system 200, the wireless communications system 300, the process flow 400, or any combination thereof. For example, the process flow 500 may include one or more UEs 115 (e.g., a UE 115-d) and one or more network entities 105 (e.g., a network entity 105-d), which may be examples of the corresponding devices as described herein. In the following description of the process flow 500, the operations between the UE 115-d and the network entity 105-d may be transmitted in a different order than the example order shown, or the operations performed by the UE 115-d and the network entity 105-d may be performed in different orders or at different times. Some operations may also be omitted from the process flow 500, and other operations may be added to the process flow 500.

At 505, the UE 115-d may receive, from the network entity 105-d, a control message indicating a configuration associated with multiple CDRX cycles of the UE 115-d (e.g., a CDRX configuration).

At 510, the UE 115-d may receive, prior to an active duration of a CDRX cycle of the multiple CDRX cycles, a WUS indicating one or more first CCs, of multiple CCs configured for the UE 115-d (e.g., according to a CA configuration), for which the UE 115-d is to monitor for control information within the active duration.

In some cases, the WUS may further indicate one or more uplink grants, one or more downlink grants, or both, are to be transmitted within the active duration. In such cases, the one or more uplink grants, the one or more downlink grants, or both, may be per CC of the multiple CCs (e.g., of the one or more first CCs). Additionally, or alternatively, the WUS may indicate a threshold rank to be scheduled within the active duration.

Thus, at 515, the UE 115-d may enter the active duration of the CDRX cycle and, at 515-a, may monitor one or more control channels (e.g., PDCCHs) associated with the one or more first CCs (e.g., within the active duration) based on the WUS. Conversely, at 515-b, the UE 115-d may refrain from monitoring one or more second CCs, of the multiple CCs configured for the UE 115-d, within the active duration based on the WUS indicating the one or more first CCs (e.g., and not the one or more second CCs).

At 520, the network entity 105-d may transmit, to the UE 115-d within the active duration via the one or more control channels associated with the one or more first CCs, the one or more messages (e.g., including the control information) based on the WUS.

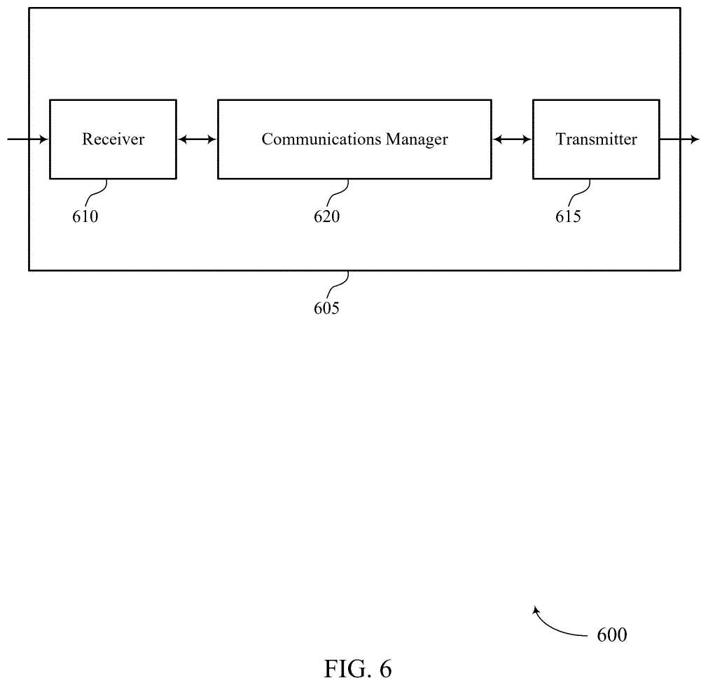

FIG. 6 shows a block diagram 600 of a device 605 that supports techniques for CDRX power savings in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for CDRX power savings). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for CDRX power savings). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of techniques for CDRX power savings as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), a graphics processing unit (GPU), a neural processing unit (NPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, a GPU, an NPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving a control message that indicates a first configuration for a set of multiple connected mode discontinuous reception (CDRX) cycles of the UE. The communications manager 620 is capable of, configured to, or operable to support a means for transmitting a response message that indicates a preferred configuration for the set of multiple CDRX cycles or indicates a request to skip one or more first CDRX cycles of the set of multiple CDRX cycles. The communications manager 620 is capable of, configured to, or operable to support a means for monitoring at least a subset of the set of multiple CDRX cycles in accordance with the response message.

Additionally, or alternatively, the communications manager 620 may support wireless communications in accordance with examples as disclosed herein. For example, the communications manager 620 is capable of, configured to, or operable to support a means for receiving a control message that indicates a configuration associated with a set of multiple connected mode discontinuous reception (CDRX) cycles of the UE. The communications manager 620 is capable of, configured to, or operable to support a means for receiving, prior to an active duration of a CDRX cycle of the set of multiple CDRX cycles, a wake up signal that indicates one or more carriers, of a set of multiple carriers configured for the UE, for which the UE is to monitor for control information within the active duration. The communications manager 620 is capable of, configured to, or operable to support a means for monitoring one or more control channels associated with the one or more carriers within the active duration of the CDRX cycle based on the wake up signal.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for CDRX power savings, which may result in reduced processing, reduced power consumption, and more efficient utilization of communication resources, among other advantages.

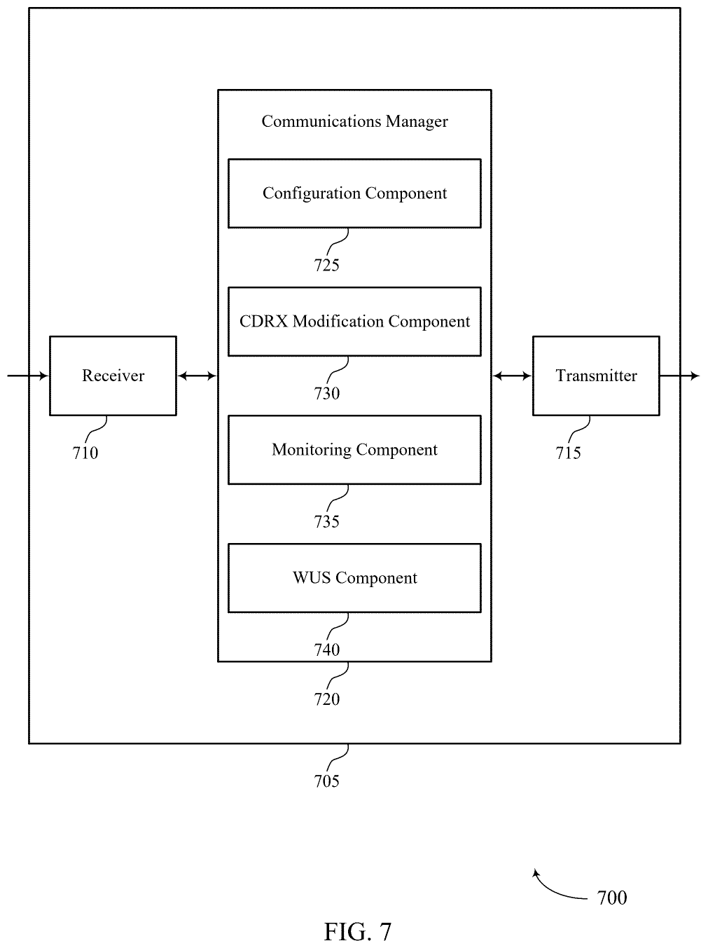

FIG. 7 shows a block diagram 700 of a device 705 that supports techniques for CDRX power savings in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for CDRX power savings). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for CDRX power savings). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for CDRX power savings as described herein. For example, the communications manager 720 may include a configuration component 725, an CDRX modification component 730, a monitoring component 735, a WUS component 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The configuration component 725 is capable of, configured to, or operable to support a means for receiving a control message that indicates a first configuration for a set of multiple connected mode discontinuous reception (CDRX) cycles of the UE. The CDRX modification component 730 is capable of, configured to, or operable to support a means for transmitting a response message that indicates a preferred configuration for the set of multiple CDRX cycles or indicates a request to skip one or more first CDRX cycles of the set of multiple CDRX cycles. The monitoring component 735 is capable of, configured to, or operable to support a means for monitoring at least a subset of the set of multiple CDRX cycles in accordance with the response message.

Additionally, or alternatively, the communications manager 720 may support wireless communications in accordance with examples as disclosed herein. The configuration component 725 is capable of, configured to, or operable to support a means for receiving a control message that indicates a configuration associated with a set of multiple connected mode discontinuous reception (CDRX) cycles of the UE. The WUS component 740 is capable of, configured to, or operable to support a means for receiving, prior to an active duration of a CDRX cycle of the set of multiple CDRX cycles, a wake up signal that indicates one or more carriers, of a set of multiple carriers configured for the UE, for which the UE is to monitor for control information within the active duration. The monitoring component 735 is capable of, configured to, or operable to support a means for monitoring one or more control channels associated with the one or more carriers within the active duration of the CDRX cycle based on the wake up signal.

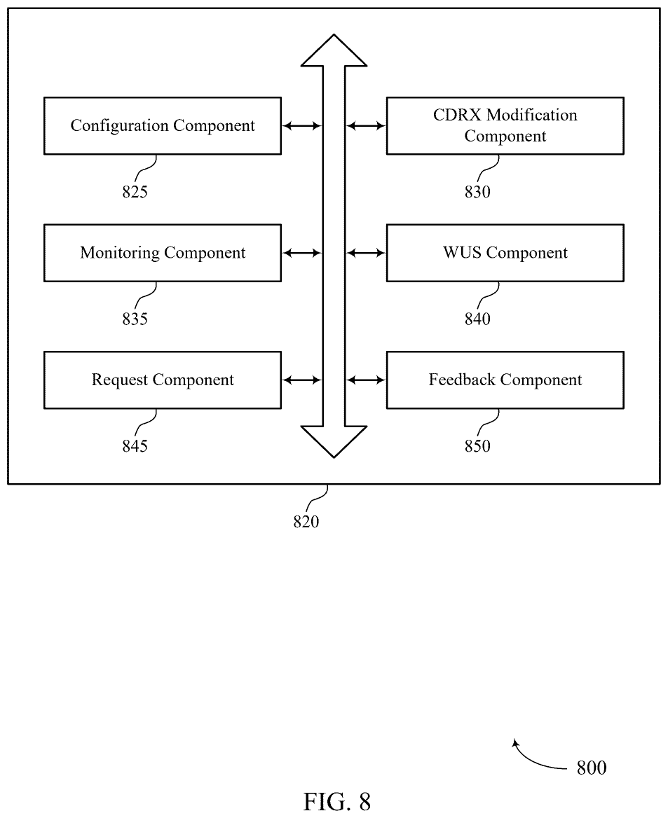

FIG. 8 shows a block diagram 800 of a communications manager 820 that supports techniques for CDRX power savings in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for CDRX power savings as described herein. For example, the communications manager 820 may include a configuration component 825, an CDRX modification component 830, a monitoring component 835, a WUS component 840, a request component 845, a feedback component 850, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The configuration component 825 is capable of, configured to, or operable to support a means for receiving a control message that indicates a first configuration for a set of multiple connected mode discontinuous reception (CDRX) cycles of the UE. The CDRX modification component 830 is capable of, configured to, or operable to support a means for transmitting a response message that indicates a preferred configuration for the set of multiple CDRX cycles or indicates a request to skip one or more first CDRX cycles of the set of multiple CDRX cycles. The monitoring component 835 is capable of, configured to, or operable to support a means for monitoring at least a subset of the set of multiple CDRX cycles in accordance with the response message.

In some examples, to support transmitting the response message, the request component 845 is capable of, configured to, or operable to support a means for transmitting a request message that indicates the preferred configuration for the set of multiple CDRX cycles, and where monitoring at least the subset of the set of multiple CDRX cycles includes. In some examples, to support transmitting the response message, the monitoring component 835 is capable of, configured to, or operable to support a means for monitoring the set of multiple CDRX cycles in accordance with the preferred configuration based on the request message.

In some examples, the configuration component 825 is capable of, configured to, or operable to support a means for receiving a second control message that indicates a set of multiple configurations for the set of multiple CDRX cycles, including at least the first configuration and the preferred configuration, and where the request message indicates the preferred configuration from the set of multiple configurations.

In some examples, the first configuration is associated with a set of values. In some examples, the request message indicates the preferred configuration via one or more offsets from the set of values.

In some examples, the feedback component 850 is capable of, configured to, or operable to support a means for receiving an acknowledgement message, responsive to the request message, that indicates the UE is to apply the preferred configuration, where the set of multiple CDRX cycles are monitored in accordance with the preferred configuration based at least in part on the acknowledgement message.

In some examples, the configuration component 825 is capable of, configured to, or operable to support a means for receiving a second control message, responsive to the request message, that indicates a second configuration for the set of multiple CDRX cycles, where the second configuration is based on the preferred configuration, and where the set of multiple CDRX cycles are monitored in accordance with the second configuration.

In some examples, to support transmitting the response message, the request component 845 is capable of, configured to, or operable to support a means for transmitting the response message that indicates the request to skip the one or more first CDRX cycles of the set of multiple CDRX cycles, where monitoring at least the subset of the set of multiple CDRX cycles includes. In some examples, to support transmitting the response message, the monitoring component 835 is capable of, configured to, or operable to support a means for monitoring one or more second CDRX cycles of the set of multiple CDRX cycles, where at least the subset of the set of multiple CDRX cycles includes the one or more second CDRX cycles and does not include the one or more first CDRX cycles.

In some examples, the monitoring component 835 is capable of, configured to, or operable to support a means for skipping monitoring of the one or more first CDRX cycles of the set of multiple CDRX cycles based on transmitting the response message.

In some examples, the feedback component 850 is capable of, configured to, or operable to support a means for receiving an acknowledgement message, responsive to the response message, that indicates the UE is to skip the one or more first CDRX cycles of the set of multiple CDRX cycles, where the one or more second CDRX cycles of the set of multiple CDRX cycles is monitored based on the acknowledgement message.

In some examples, to support transmitting the response message, the CDRX modification component 830 is capable of, configured to, or operable to support a means for transmitting the response message that indicates the UE is to skip monitoring for one or more first uplink control grants, one or more first downlink grants, or both, within the one or more first CDRX cycles, where monitoring at least the subset of the set of multiple CDRX cycles includes. In some examples, to support transmitting the response message, the monitoring component 835 is capable of, configured to, or operable to support a means for monitoring for second uplink grants, second downlink grants, or both, within one or more second CDRX cycles based on the response message, where at least the subset of the set of multiple CDRX cycles includes the one or more second CDRX cycles and does not include the one or more first CDRX cycles.

In some examples, the monitoring component 835 is capable of, configured to, or operable to support a means for skipping monitoring for the one or more first uplink control grants, the one or more first downlink grants, or both, within the one or more first CDRX cycles based on the response message.

In some examples, the feedback component 850 is capable of, configured to, or operable to support a means for receiving an acknowledgement message, responsive to the response message, that indicates the UE is to skip monitoring for the one or more first uplink control grants, the one or more first downlink grants, or both, within the one or more first CDRX cycles, where skipping monitoring for the one or more first uplink control grants, the one or more first downlink grants, or both, is based on receiving the acknowledgement message.

In some examples, the response message indicates the UE is to skip monitoring of monitoring for the one or more first uplink control grants, the one or more first downlink grants, or both, within the one or more first CDRX cycles across one or more component carriers of a set of multiple component carriers configured for the UE.

In some examples, the response message is a medium access control-control element (MAC-CE) message or a DCI message.

Additionally, or alternatively, the communications manager 820 may support wireless communications in accordance with examples as disclosed herein. In some examples, the configuration component 825 is capable of, configured to, or operable to support a means for receiving a control message that indicates a configuration associated with a set of multiple connected mode discontinuous reception (CDRX) cycles of the UE. The WUS component 840 is capable of, configured to, or operable to support a means for receiving, prior to an active duration of a CDRX cycle of the set of multiple CDRX cycles, a wake up signal that indicates one or more carriers, of a set of multiple carriers configured for the UE, for which the UE is to monitor for control information within the active duration. In some examples, the monitoring component 835 is capable of, configured to, or operable to support a means for monitoring one or more control channels associated with the one or more carriers within the active duration of the CDRX cycle based on the wake up signal.

In some examples, the monitoring component 835 is capable of, configured to, or operable to support a means for refraining from monitoring one or more second carriers, of a set of multiple carriers configured for the UE, for control information within the active duration based on the wake up signal indicating the one or more carriers.

In some examples, the wake up signal further indicates that one or more uplink grants, one or more downlink grants, or both, are to be transmitted within the active duration. In some examples, the one or more control channels are monitored for the one or more uplink grants, the one or more downlink grants, or both, based on the wake up signal indicating the one or more uplink grants, the one or more downlink grants, or both, are to be transmitted.

In some examples, the wake up signal further indicates the one or more uplink grants, the one or more downlink grants, or both, per carrier of the one or more carriers.

In some examples, the wake up signal further indicates a threshold rank to be scheduled within the active duration. In some examples, monitoring the one or more control channels associated with the one or more carriers within the active duration of the CDRX cycle is based on the threshold rank.

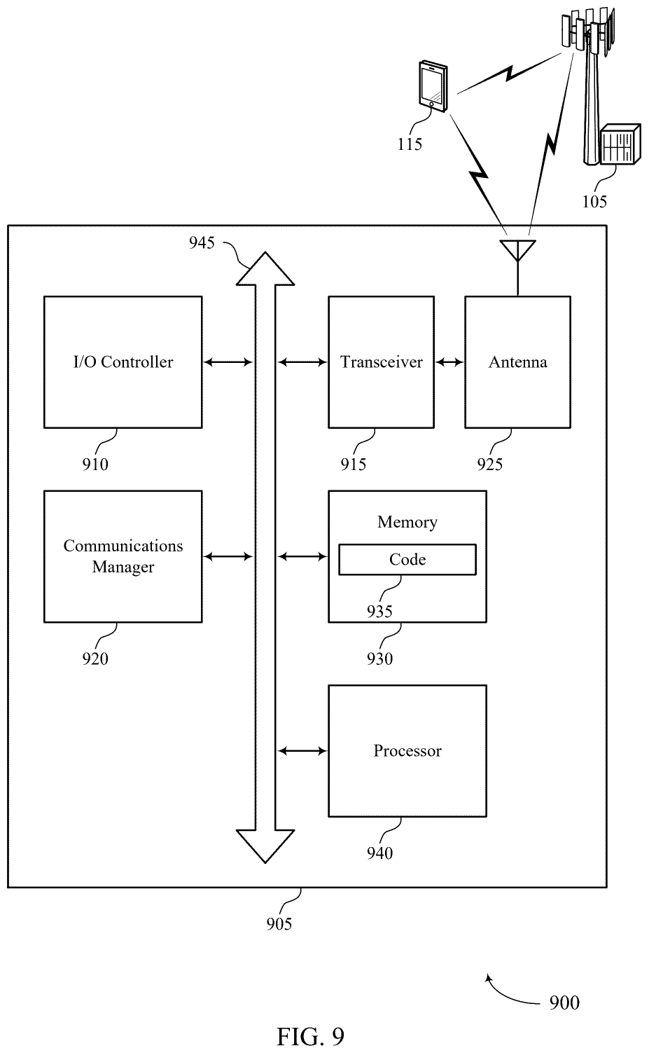

FIG. 9 shows a diagram of a system 900 including a device 905 that supports techniques for CDRX power savings in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more GPUs, one or more NPUs (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting techniques for CDRX power savings). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving a control message that indicates a first configuration for a set of multiple connected mode discontinuous reception (CDRX) cycles of the UE. The communications manager 920 is capable of, configured to, or operable to support a means for transmitting a response message that indicates a preferred configuration for the set of multiple CDRX cycles or indicates a request to skip one or more first CDRX cycles of the set of multiple CDRX cycles. The communications manager 920 is capable of, configured to, or operable to support a means for monitoring at least a subset of the set of multiple CDRX cycles in accordance with the response message.

Additionally, or alternatively, the communications manager 920 may support wireless communications in accordance with examples as disclosed herein. For example, the communications manager 920 is capable of, configured to, or operable to support a means for receiving a control message that indicates a configuration associated with a set of multiple connected mode discontinuous reception (CDRX) cycles of the UE. The communications manager 920 is capable of, configured to, or operable to support a means for receiving, prior to an active duration of a CDRX cycle of the set of multiple CDRX cycles, a wake up signal that indicates one or more carriers, of a set of multiple carriers configured for the UE, for which the UE is to monitor for control information within the active duration. The communications manager 920 is capable of, configured to, or operable to support a means for monitoring one or more control channels associated with the one or more carriers within the active duration of the CDRX cycle based on the wake up signal.

By including or configuring the communications manager 920 in accordance with examples as described herein, the device 905 may support techniques for CDRX power savings, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of techniques for CDRX power savings as described herein, or the at least one processor 940 and the at least one memory 930 may be otherwise configured to, individually or collectively, perform or support such operations.

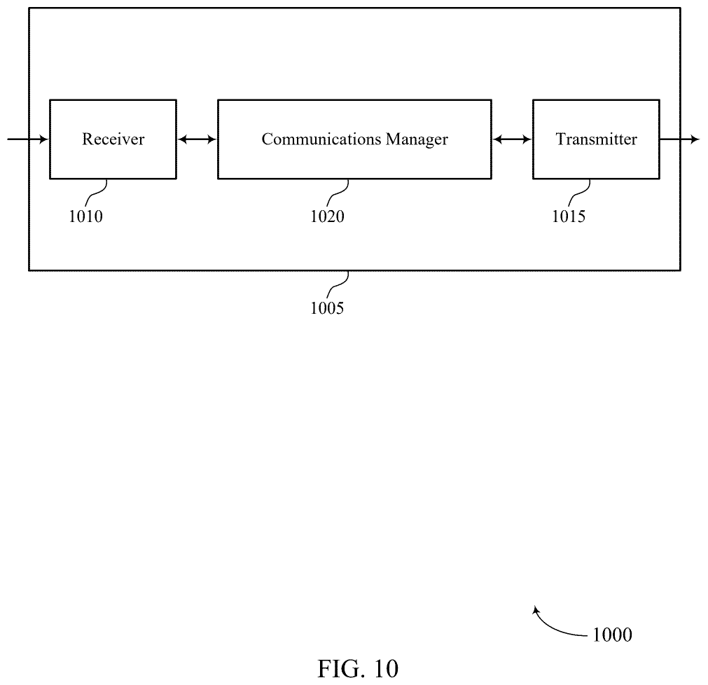

FIG. 10 shows a block diagram 1000 of a device 1005 that supports techniques for CDRX power savings in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of techniques for CDRX power savings as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, a GPU, an NPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, a GPU, an NPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for transmitting a control message that indicates a first configuration for a set of multiple connected mode discontinuous reception (CDRX) cycles of a UE. The communications manager 1020 is capable of, configured to, or operable to support a means for receiving a response message that indicates a preferred configuration of the UE for the set of multiple CDRX cycles or indicates a request for the UE to skip one or more first CDRX cycles of the set of multiple CDRX cycles. The communications manager 1020 is capable of, configured to, or operable to support a means for transmitting one or more messages within at least a subset of the set of multiple CDRX cycles in accordance with the response message.

Additionally, or alternatively, the communications manager 1020 may support wireless communications in accordance with examples as disclosed herein. For example, the communications manager 1020 is capable of, configured to, or operable to support a means for transmitting a control message that indicates a configuration associated with a set of multiple connected mode discontinuous reception (CDRX) cycles of a UE. The communications manager 1020 is capable of, configured to, or operable to support a means for transmitting, prior to an active duration of a CDRX cycle of the set of multiple CDRX cycles, a wake up signal that indicates one or more carriers, of a set of multiple carriers configured for the UE, for which the UE is to monitor for control information within the active duration. The communications manager 1020 is capable of, configured to, or operable to support a means for transmitting one or more messages via one or more control channels associated with the one or more carriers within the active duration of the CDRX cycle based on the wake up signal.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for CDRX power savings, which may result in reduced processing, reduced power consumption, and more efficient utilization of communication resources, among other advantages.

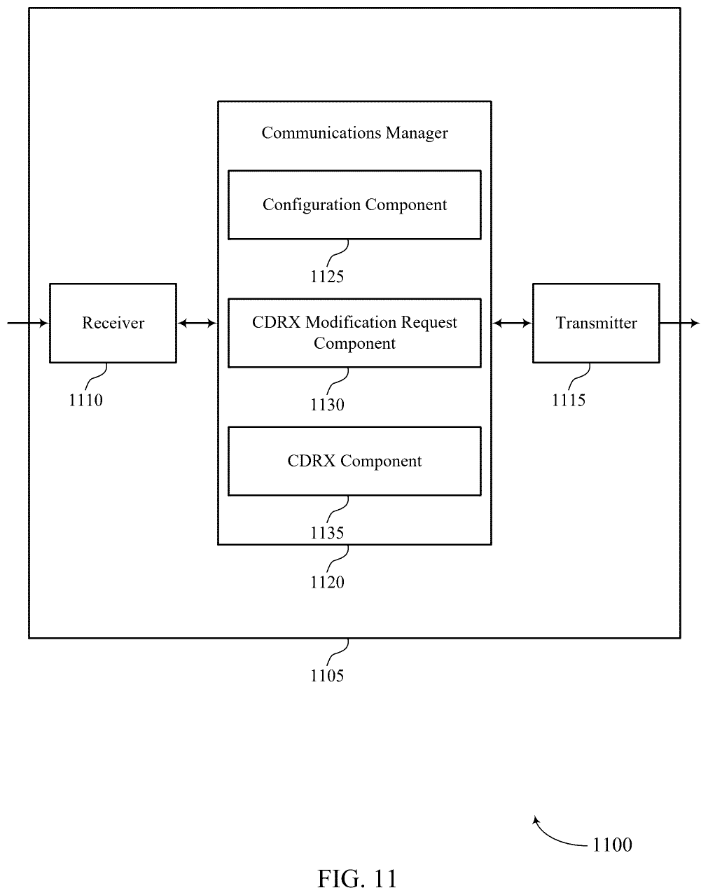

FIG. 11 shows a block diagram 1100 of a device 1105 that supports techniques for CDRX power savings in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of techniques for CDRX power savings as described herein. For example, the communications manager 1120 may include a configuration component 1125, an CDRX modification request component 1130, an CDRX component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The configuration component 1125 is capable of, configured to, or operable to support a means for transmitting a control message that indicates a first configuration for a set of multiple connected mode discontinuous reception (CDRX) cycles of a UE. The CDRX modification request component 1130 is capable of, configured to, or operable to support a means for receiving a response message that indicates a preferred configuration of the UE for the set of multiple CDRX cycles or indicates a request for the UE to skip one or more first CDRX cycles of the set of multiple CDRX cycles. The CDRX component 1135 is capable of, configured to, or operable to support a means for transmitting one or more messages within at least a subset of the set of multiple CDRX cycles in accordance with the response message.

Additionally, or alternatively, the communications manager 1120 may support wireless communications in accordance with examples as disclosed herein. The configuration component 1125 is capable of, configured to, or operable to support a means for transmitting a control message that indicates a configuration associated with a set of multiple connected mode discontinuous reception (CDRX) cycles of a UE. The CDRX component 1135 is capable of, configured to, or operable to support a means for transmitting, prior to an active duration of a CDRX cycle of the set of multiple CDRX cycles, a wake up signal that indicates one or more carriers, of a set of multiple carriers configured for the UE, for which the UE is to monitor for control information within the active duration. The CDRX component 1135 is capable of, configured to, or operable to support a means for transmitting one or more messages via one or more control channels associated with the one or more carriers within the active duration of the CDRX cycle based on the wake up signal.

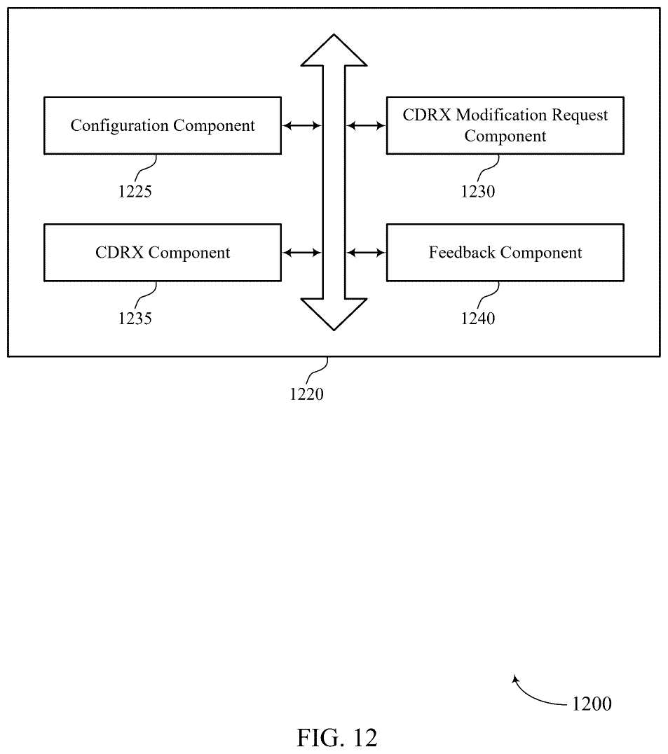

FIG. 12 shows a block diagram 1200 of a communications manager 1220 that supports techniques for CDRX power savings in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for CDRX power savings as described herein. For example, the communications manager 1220 may include a configuration component 1225, an CDRX modification request component 1230, an CDRX component 1235, a feedback component 1240, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The configuration component 1225 is capable of, configured to, or operable to support a means for transmitting a control message that indicates a first configuration for a set of multiple connected mode discontinuous reception (CDRX) cycles of a UE. The CDRX modification request component 1230 is capable of, configured to, or operable to support a means for receiving a response message that indicates a preferred configuration of the UE for the set of multiple CDRX cycles or indicates a request for the UE to skip one or more first CDRX cycles of the set of multiple CDRX cycles. The CDRX component 1235 is capable of, configured to, or operable to support a means for transmitting one or more messages within at least a subset of the set of multiple CDRX cycles in accordance with the response message.

In some examples, to support receiving the response message, the CDRX modification request component 1230 is capable of, configured to, or operable to support a means for receiving a request message that indicates the preferred configuration for the set of multiple CDRX cycles, where transmitting the one or more messages within at least the subset of the set of multiple CDRX cycles includes. In some examples, to support receiving the response message, the CDRX component 1235 is capable of, configured to, or operable to support a means for transmitting the one or more messages within the set of multiple CDRX cycles in accordance with the preferred configuration based on the request message.

In some examples, the configuration component 1225 is capable of, configured to, or operable to support a means for transmitting a second control message that indicates a set of multiple configurations for the set of multiple CDRX cycles, including at least the first configuration and the preferred configuration, and where the request message indicates the preferred configuration from the set of multiple configurations.

In some examples, the first configuration is associated with a set of values. In some examples, the request message indicates the preferred configuration via one or more offsets from the set of values.

In some examples, the feedback component 1240 is capable of, configured to, or operable to support a means for transmitting an acknowledgement message, responsive to the request message, that indicates the UE is to apply the preferred configuration, where the set of multiple CDRX cycles are monitored in accordance with the preferred configuration.

In some examples, the configuration component 1225 is capable of, configured to, or operable to support a means for transmitting a second control message, responsive to the request message, that indicates a second configuration for the set of multiple CDRX cycles, where the second configuration is based on the preferred configuration, and where the set of multiple CDRX cycles are monitored in accordance with the second configuration.

In some examples, to support receiving the response message, the CDRX modification request component 1230 is capable of, configured to, or operable to support a means for receiving the response message that indicates the request to skip the one or more first CDRX cycles of the set of multiple CDRX cycles, where transmitting the one or more messages within at least the subset of the set of multiple CDRX cycles includes. In some examples, to support receiving the response message, the CDRX component 1235 is capable of, configured to, or operable to support a means for transmitting the one or more messages within one or more second CDRX cycles of the set of multiple CDRX cycles based on the response message, where at least the subset of the set of multiple CDRX cycles includes the one or more second CDRX cycles and does not include the one or more first CDRX cycles.

In some examples, the feedback component 1240 is capable of, configured to, or operable to support a means for transmitting an acknowledgement message, responsive to the response message, that indicates the UE is to skip the one or more first CDRX cycles of the set of multiple CDRX cycles, where the one or more messages is transmitted within one or more second CDRX cycles of the set of multiple CDRX cycles based on transmitting the acknowledgement message.

In some examples, to support receiving the response message, the CDRX modification request component 1230 is capable of, configured to, or operable to support a means for receiving the response message that indicates the UE is to skip monitoring for one or more first uplink control grants, one or more first downlink grants, or both, within the one or more first CDRX cycles, where transmitting the one or more messages within at least the subset of the set of multiple CDRX cycles includes. In some examples, to support receiving the response message, the CDRX component 1235 is capable of, configured to, or operable to support a means for transmitting one or more second uplink grants, one or more second downlink grants, or both, within one or more second CDRX cycles based on the response message, where at least the subset of the set of multiple CDRX cycles includes the one or more second CDRX cycles and does not include the one or more first CDRX cycles, and where the one or more messages includes the one or more second uplink grants, the one or more second downlink grants, or both.

In some examples, the feedback component 1240 is capable of, configured to, or operable to support a means for transmitting an acknowledgement message, responsive to the response message, that indicates the UE is to skip monitoring for the one or more first uplink control grants, the one or more first downlink grants, or both, within the one or more first CDRX cycles, where the one or more second uplink grants, the one or more second downlink grants, or both, is transmitted within one or more second CDRX cycles based on transmitting the acknowledgement message.

In some examples, the response message indicates the UE is to skip monitoring of monitoring for the one or more first uplink control grants, the one or more first downlink grants, or both, within the one or more first CDRX cycles across one or more component carriers of a set of multiple component carriers configured for the UE.

In some examples, the response message is a medium access control-control element (MAC-CE) message or a DCI message.

Additionally, or alternatively, the communications manager 1220 may support wireless communications in accordance with examples as disclosed herein. In some examples, the configuration component 1225 is capable of, configured to, or operable to support a means for transmitting a control message that indicates a configuration associated with a set of multiple connected mode discontinuous reception (CDRX) cycles of a UE. In some examples, the CDRX component 1235 is capable of, configured to, or operable to support a means for transmitting, prior to an active duration of a CDRX cycle of the set of multiple CDRX cycles, a wake up signal that indicates one or more carriers, of a set of multiple carriers configured for the UE, for which the UE is to monitor for control information within the active duration. In some examples, the CDRX component 1235 is capable of, configured to, or operable to support a means for transmitting one or more messages via one or more control channels associated with the one or more carriers within the active duration of the CDRX cycle based on the wake up signal.

In some examples, the wake up signal further indicates that one or more uplink grants, one or more downlink grants, or both, are to be transmitted within the active duration. In some examples, the one or more control channels are monitored for the one or more uplink grants, the one or more downlink grants, or both, based on the wake up signal indicating the one or more uplink grants, the one or more downlink grants, or both, are to be transmitted.

In some examples, the wake up signal further indicates the one or more uplink grants, the one or more downlink grants, or both, per carrier of the one or more carriers.

In some examples, the wake up signal further indicates a threshold rank to be scheduled within the active duration. In some examples, monitoring the one or more control channels associated with the one or more carriers within the active duration of the CDRX cycle is based on the threshold rank.

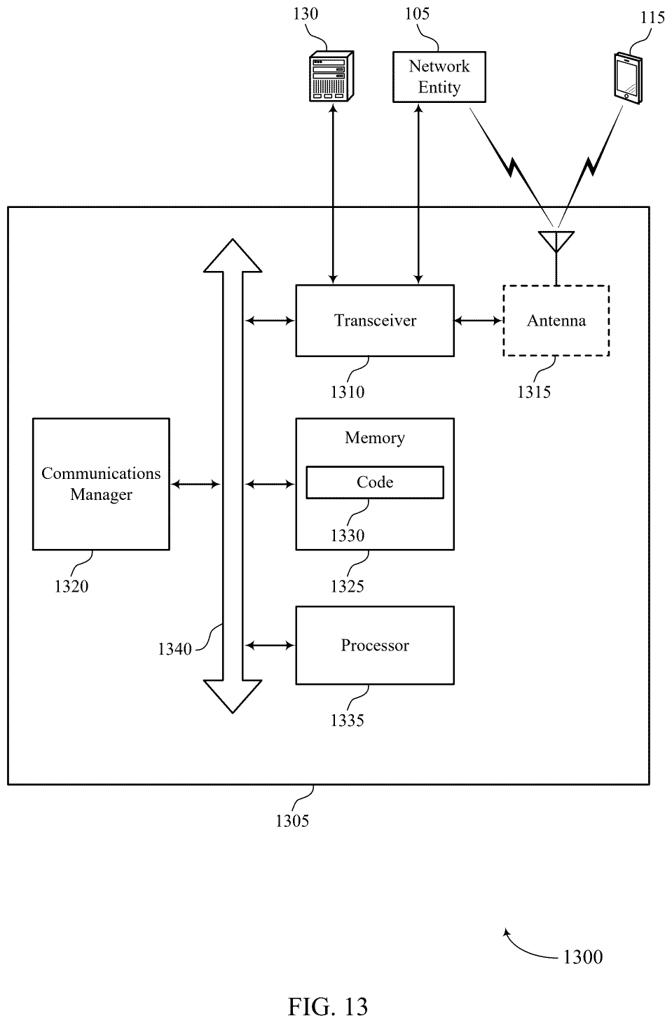

FIG. 13 shows a diagram of a system 1300 including a device 1305 that supports techniques for CDRX power savings in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more GPUs, one or more NPUs (also referred to as neural network processors or DLPs), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting techniques for CDRX power savings). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for transmitting a control message that indicates a first configuration for a set of multiple connected mode discontinuous reception (CDRX) cycles of a UE. The communications manager 1320 is capable of, configured to, or operable to support a means for receiving a response message that indicates a preferred configuration of the UE for the set of multiple CDRX cycles or indicates a request for the UE to skip one or more first CDRX cycles of the set of multiple CDRX cycles. The communications manager 1320 is capable of, configured to, or operable to support a means for transmitting one or more messages within at least a subset of the set of multiple CDRX cycles in accordance with the response message.

Additionally, or alternatively, the communications manager 1320 may support wireless communications in accordance with examples as disclosed herein. For example, the communications manager 1320 is capable of, configured to, or operable to support a means for transmitting a control message that indicates a configuration associated with a set of multiple connected mode discontinuous reception (CDRX) cycles of a UE. The communications manager 1320 is capable of, configured to, or operable to support a means for transmitting, prior to an active duration of a CDRX cycle of the set of multiple CDRX cycles, a wake up signal that indicates one or more carriers, of a set of multiple carriers configured for the UE, for which the UE is to monitor for control information within the active duration. The communications manager 1320 is capable of, configured to, or operable to support a means for transmitting one or more messages via one or more control channels associated with the one or more carriers within the active duration of the CDRX cycle based on the wake up signal.

By including or configuring the communications manager 1320 in accordance with examples as described herein, the device 1305 may support techniques for CDRX power savings, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of techniques for CDRX power savings as described herein, or the at least one processor 1335 and the at least one memory 1325 may be otherwise configured to, individually or collectively, perform or support such operations.

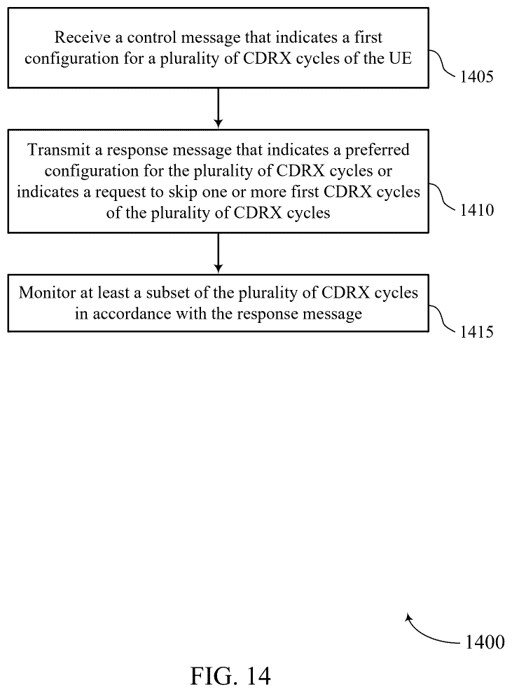

FIG. 14 shows a flowchart illustrating a method 1400 that supports techniques for CDRX power savings in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving control message that indicates a first configuration for a plurality of CDRX cycles of the UE. The operations of 1405 may be performed in accordance with examples as disclosed herein. In some examples, aspects of the operations of 1405 may be performed by a configuration component 825 as described with reference to FIG. 8.

At 1410, the method may include transmitting a response message that indicates a preferred configuration for the plurality of CDRX cycles or indicates a request to skip one or more first CDRX cycles of the plurality of CDRX cycles. The operations of 1410 may be performed in accordance with examples as disclosed herein. In some examples, aspects of the operations of 1410 may be performed by an CDRX modification component 830 as described with reference to FIG. 8.

At 1415, the method may include monitoring at least a subset of the plurality of CDRX cycles in accordance with the response message. The operations of 1415 may be performed in accordance with examples as disclosed herein. In some examples, aspects of the operations of 1415 may be performed by a monitoring component 835 as described with reference to FIG. 8.

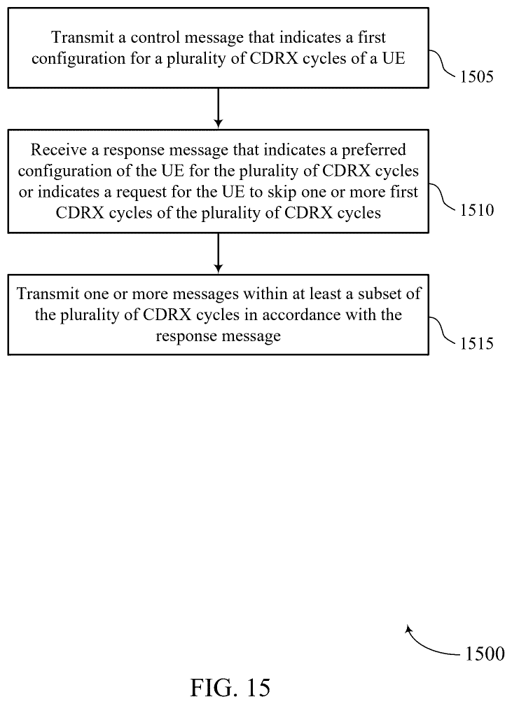

FIG. 15 shows a flowchart illustrating a method 1500 that supports techniques for CDRX power savings in accordance with one or more aspects of the present disclosure. The operations of the method 1500 may be implemented by a network entity or its components as described herein. For example, the operations of the method 1500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include transmitting a control message that indicates a first configuration for a plurality of CDRX cycles of a UE. The operations of 1505 may be performed in accordance with examples as disclosed herein. In some examples, aspects of the operations of 1505 may be performed by a configuration component 1225 as described with reference to FIG. 12.

At 1510, the method may include receiving a response message that indicates a preferred configuration of the UE for the plurality of CDRX cycles or indicates a request for the UE to skip one or more first CDRX cycles of the plurality of CDRX cycles. The operations of 1510 may be performed in accordance with examples as disclosed herein. In some examples, aspects of the operations of 1510 may be performed by an CDRX modification request component 1230 as described with reference to FIG. 12.

At 1515, the method may include transmitting one or more messages within at least a subset of the plurality of CDRX cycles in accordance with the response message. The operations of 1515 may be performed in accordance with examples as disclosed herein. In some examples, aspects of the operations of 1515 may be performed by an CDRX component 1235 as described with reference to FIG. 12.

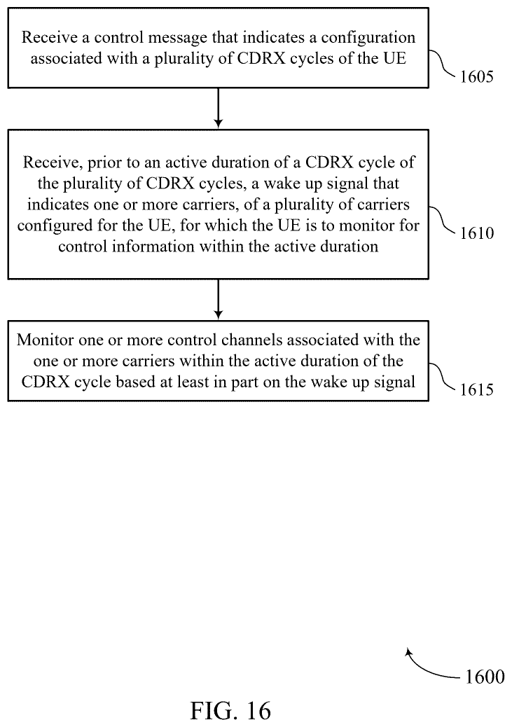

FIG. 16 shows a flowchart illustrating a method 1600 that supports techniques for CDRX power savings in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving a control message that indicates a configuration associated with a plurality of CDRX cycles of the UE. The operations of 1605 may be performed in accordance with examples as disclosed herein. In some examples, aspects of the operations of 1605 may be performed by a configuration component 825 as described with reference to FIG. 8.

At 1610, the method may include receiving, prior to an active duration of a CDRX cycle of the plurality of CDRX cycles, a wake up signal that indicates one or more carriers, of a plurality of carriers configured for the UE, for which the UE is to monitor for control information within the active duration. The operations of 1610 may be performed in accordance with examples as disclosed herein. In some examples, aspects of the operations of 1610 may be performed by a WUS component 840 as described with reference to FIG. 8.

At 1615, the method may include monitoring one or more control channels associated with the one or more carriers within the active duration of the CDRX cycle based at least in part on the wake up signal. The operations of 1615 may be performed in accordance with examples as disclosed herein. In some examples, aspects of the operations of 1615 may be performed by a monitoring component 835 as described with reference to FIG. 8.

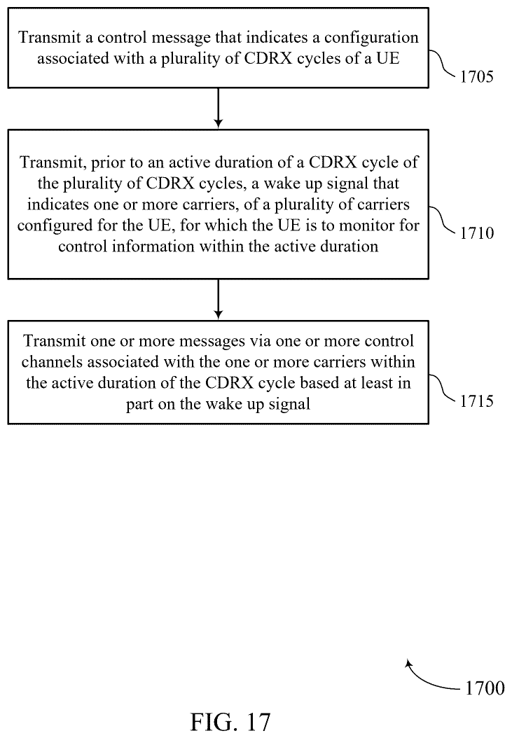

FIG. 17 shows a flowchart illustrating a method 1700 that supports techniques for CDRX power savings in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include transmitting a control message that indicates a configuration associated with a plurality of CDRX cycles of a UE. The operations of 1705 may be performed in accordance with examples as disclosed herein. In some examples, aspects of the operations of 1705 may be performed by a configuration component 1225 as described with reference to FIG. 12.

At 1710, the method may include transmitting, prior to an active duration of a CDRX cycle of the plurality of CDRX cycles, a wake up signal that indicates one or more carriers, of a plurality of carriers configured for the UE, for which the UE is to monitor for control information within the active duration. The operations of 1710 may be performed in accordance with examples as disclosed herein. In some examples, aspects of the operations of 1710 may be performed by an CDRX component 1235 as described with reference to FIG. 12.

At 1715, the method may include transmitting one or more messages via one or more control channels associated with the one or more carriers within the active duration of the CDRX cycle based at least in part on the wake up signal. The operations of 1715 may be performed in accordance with examples as disclosed herein. In some examples, aspects of the operations of 1715 may be performed by an CDRX component 1235 as described with reference to FIG. 12.

The following provides an overview of aspects of the present disclosure:

Aspect 1: A method for wireless communications at a UE, comprising: receiving a control message that indicates a first configuration for a plurality of CDRX cycles of the UE; transmitting a response message that indicates a preferred configuration for the plurality of CDRX cycles or indicates a request to skip one or more first CDRX cycles of the plurality of CDRX cycles; and monitoring at least a subset of the plurality of CDRX cycles in accordance with the response message.

Aspect 2: The method of aspect 1, wherein transmitting the response message comprises: transmitting a request message that indicates the preferred configuration for the plurality of CDRX cycles, and wherein monitoring at least the subset of the plurality of CDRX cycles comprises: monitoring the plurality of CDRX cycles in accordance with the preferred configuration based at least in part on the request message.

Aspect 3: The method of aspect 2, further comprising: receiving a second control message that indicates a plurality of configurations for the plurality of CDRX cycles, including at least the first configuration and the preferred configuration, and wherein the request message indicates the preferred configuration from the plurality of configurations.

Aspect 4: The method of any of aspects 2 through 3, wherein the first configuration is associated with a set of values, and the request message indicates the preferred configuration via one or more offsets from the set of values.

Aspect 5: The method of any of aspects 2 through 4, further comprising: receiving an acknowledgment message, responsive to the request message, that indicates the UE is to apply the preferred configuration, wherein the plurality of CDRX cycles are monitored in accordance with the preferred configuration is at least in part on the preferred configuration.

Aspect 6: The method of any of aspects 2 through 5, further comprising: receiving a second control message, responsive to the request message, that indicates a second configuration for the plurality of CDRX cycles, wherein the second configuration is based at least in part on the preferred configuration, and wherein the plurality of CDRX cycles are monitored in accordance with the second configuration.

Aspect 7: The method of any of aspects 1 through 6, wherein transmitting the response message comprises: transmitting the response message that indicates the request to skip the one or more first CDRX cycles of the plurality of CDRX cycles, wherein monitoring at least the subset of the plurality of CDRX cycles comprises: monitoring one or more second CDRX cycles of the plurality of CDRX cycles, wherein at least the subset of the plurality of CDRX cycles comprises the one or more second CDRX cycles and does not comprise the one or more first CDRX cycles.

Aspect 8: The method of aspect 7, further comprising: skipping monitoring of the one or more first CDRX cycles of the plurality of CDRX cycles based at least in part on transmitting the response message.

Aspect 9: The method of any of aspects 7 through 8, further comprising: receiving an acknowledgment message, responsive to the response message, that indicates the UE is to skip the one or more first CDRX cycles of the plurality of CDRX cycles, wherein the one or more second CDRX cycles of the plurality of CDRX cycles is monitored based at least in part on the acknowledgment message.

Aspect 10: The method of any of aspects 1 through 9, wherein transmitting the response message comprises: transmitting the response message that indicates the UE is to skip monitoring for one or more first uplink control grants, one or more first downlink grants, or both, within the one or more first CDRX cycles, wherein monitoring at least the subset of the plurality of CDRX cycles comprises: monitoring for second uplink grants, second downlink grants, or both, within one or more second CDRX cycles based at least in part on the response message, wherein at least the subset of the plurality of CDRX cycles comprises the one or more second CDRX cycles and does not comprise the one or more first CDRX cycles.

Aspect 11: The method of aspect 10, further comprising: skipping monitoring for the one or more first uplink control grants, the one or more first downlink grants, or both, within the one or more first CDRX cycles based at least in part on the response message.

Aspect 12: The method of aspect 11, further comprising: receiving an acknowledgment message, responsive to the response message, that indicates the UE is to skip monitoring for the one or more first uplink control grants, the one or more first downlink grants, or both, within the one or more first CDRX cycles, wherein skipping monitoring for the one or more first uplink control grants, the one or more first downlink grants, or both, is based at least in part on receiving the acknowledgment message.

Aspect 13: The method of any of aspects 10 through 12, wherein the response message indicates the UE is to skip monitoring of monitoring for the one or more first uplink control grants, the one or more first downlink grants, or both, within the one or more first CDRX cycles across one or more component carriers of a plurality of component carriers configured for the UE.

Aspect 14: The method of any of aspects 1 through 13, wherein the response message is a MAC-CE message or a DCI message.

Aspect 15: A method for wireless communications at a network entity, comprising: transmitting a control message that indicates a first configuration for a plurality of CDRX cycles of a UE; receiving a response message that indicates a preferred configuration of the UE for the plurality of CDRX cycles or indicates a request for the UE to skip one or more first CDRX cycles of the plurality of CDRX cycles; and transmitting one or more messages within at least a subset of the plurality of CDRX cycles in accordance with the response message.

Aspect 16: The method of aspect 15, wherein receiving the response message comprises: receiving a request message that indicates the preferred configuration for the plurality of CDRX cycles, wherein transmitting the one or more messages within at least the subset of the plurality of CDRX cycles comprises: transmitting the one or more messages within the plurality of CDRX cycles in accordance with the preferred configuration based at least in part on the request message.

Aspect 17: The method of aspect 16, further comprising: transmitting a second control message that indicates a plurality of configurations for the plurality of CDRX cycles, including at least the first configuration and the preferred configuration, and wherein the request message indicates the preferred configuration from the plurality of configurations.

Aspect 18: The method of any of aspects 16 through 17, wherein the first configuration is associated with a set of values, and the request message indicates the preferred configuration via one or more offsets from the set of values.

Aspect 19: The method of any of aspects 16 through 18, further comprising: transmitting an acknowledgment message, responsive to the request message, that indicates the UE is to apply the preferred configuration, wherein the plurality of CDRX cycles are monitored in accordance with the preferred configuration.

Aspect 20: The method of any of aspects 16 through 19, further comprising: transmitting a second control message, responsive to the request message, that indicates a second configuration for the plurality of CDRX cycles, wherein the second configuration is based at least in part on the preferred configuration, and wherein the plurality of CDRX cycles are monitored in accordance with the second configuration.

Aspect 21: The method of any of aspects 16 through 20, wherein receiving the response message comprises: receiving the response message that indicates the request to skip the one or more first CDRX cycles of the plurality of CDRX cycles, wherein transmitting the one or more messages within at least the subset of the plurality of CDRX cycles comprises: transmitting the one or more messages within one or more second CDRX cycles of the plurality of CDRX cycles based at least in part on the response message, wherein at least the subset of the plurality of CDRX cycles comprises the one or more second CDRX cycles and does not comprise the one or more first CDRX cycles.

Aspect 22: The method of aspect 21, further comprising: transmitting an acknowledgment message, responsive to the response message, that indicates the UE is to skip the one or more first CDRX cycles of the plurality of CDRX cycles, wherein the one or more messages is transmitted within one or more second CDRX cycles of the plurality of CDRX cycles based at least in part on transmitting the acknowledgment message.

Aspect 23: The method of any of aspects 16 through 22, wherein receiving the response message comprises: receiving the response message that indicates the UE is to skip monitoring for one or more first uplink control grants, one or more first downlink grants, or both, within the one or more first CDRX cycles, wherein transmitting the one or more messages within at least the subset of the plurality of CDRX cycles comprises: transmitting one or more second uplink grants, one or more second downlink grants, or both, within one or more second CDRX cycles based at least in part on the response message, wherein at least the subset of the plurality of CDRX cycles comprises the one or more second CDRX cycles and does not comprise the one or more first CDRX cycles, and wherein the one or more messages comprises the one or more second uplink grants, the one or more second downlink grants, or both.

Aspect 24: The method of aspect 23, further comprising: transmitting an acknowledgment message, responsive to the response message, that indicates the UE is to skip monitoring for the one or more first uplink control grants, the one or more first downlink grants, or both, within the one or more first CDRX cycles, wherein the one or more second uplink grants, the one or more second downlink grants, or both, is transmitted within one or more second CDRX cycles based at least in part on transmitting the acknowledgment message.

Aspect 25: The method of any of aspects 23 through 24, wherein the response message indicates the UE is to skip monitoring of monitoring for the one or more first uplink control grants, the one or more first downlink grants, or both, within the one or more first CDRX cycles across one or more component carriers of a plurality of component carriers configured for the UE.

Aspect 26: The method of any of aspects 16 through 25, wherein the response message is a MAC-CE message or a DCI message.

Aspect 27: A method for wireless communications at a UE, comprising: receiving a control message that indicates a configuration associated with a plurality of CDRX cycles of the UE; receiving, prior to an active duration of a CDRX cycle of the plurality of CDRX cycles, a wake up signal that indicates one or more carriers, of a plurality of carriers configured for the UE, for which the UE is to monitor for control information within the active duration; and monitoring one or more control channels associated with the one or more carriers within the active duration of the CDRX cycle based at least in part on the wake up signal.

Aspect 28: The method of aspect 27, further comprising: refraining from monitoring one or more second carriers, of a plurality of carriers configured for the UE, for control information within the active duration based at least in part on the wake up signal indicating the one or more carriers.

Aspect 29: The method of any of aspects 27 through 28, wherein the wake up signal further indicates that one or more uplink grants, one or more downlink grants, or both, are to be transmitted within the active duration, and the one or more control channels are monitored for the one or more uplink grants, the one or more downlink grants, or both, based at least in part on the wake up signal indicating the one or more uplink grants, the one or more downlink grants, or both, are to be transmitted.

Aspect 30: The method of aspect 29, wherein the wake up signal further indicates the one or more uplink grants, the one or more downlink grants, or both, per carrier of the one or more carriers.

Aspect 31: The method of any of aspects 27 through 30, wherein the wake up signal further indicates a threshold rank to be scheduled within the active duration, and monitoring the one or more control channels associated with the one or more carriers within the active duration of the CDRX cycle is based at least in part on the threshold rank.

Aspect 32: A method for wireless communications at a network entity, comprising: transmitting a control message that indicates a configuration associated with a plurality of CDRX cycles of a UE; transmitting, prior to an active duration of a CDRX cycle of the plurality of CDRX cycles, a wake up signal that indicates one or more carriers, of a plurality of carriers configured for the UE, for which the UE is to monitor for control information within the active duration; and transmitting one or more messages via one or more control channels associated with the one or more carriers within the active duration of the CDRX cycle based at least in part on the wake up signal.

Aspect 33: The method of aspect 32, wherein the wake up signal further indicates that one or more uplink grants, one or more downlink grants, or both, are to be transmitted within the active duration, and the one or more control channels are monitored for the one or more uplink grants, the one or more downlink grants, or both, based at least in part on the wake up signal indicating the one or more uplink grants, the one or more downlink grants, or both, are to be transmitted.

Aspect 34: The method of aspect 33, wherein the wake up signal further indicates the one or more uplink grants, the one or more downlink grants, or both, per carrier of the one or more carriers.

Aspect 35: The method of any of aspects 32 through 34, wherein the wake up signal further indicates a threshold rank to be scheduled within the active duration, and monitoring the one or more control channels associated with the one or more carriers within the active duration of the CDRX cycle is based at least in part on the threshold rank.

Aspect 36: A UE for wireless communications, comprising one or more memories storing processor-executable code, and one or more processors coupled with the one or more memories and individually or collectively operable to execute the code to cause the UE to perform a method of any of aspects 1 through 14.

Aspect 37: A UE for wireless communications, comprising at least one means for performing a method of any of aspects 1 through 14.

Aspect 38: A non-transitory computer-readable medium storing code for wireless communications, the code comprising instructions executable by one or more processors to perform a method of any of aspects 1 through 14.

Aspect 39: A network entity for wireless communications, comprising one or more memories storing processor-executable code, and one or more processors coupled with the one or more memories and individually or collectively operable to execute the code to cause the network entity to perform a method of any of aspects 15 through 26.

Aspect 40: A network entity for wireless communications, comprising at least one means for performing a method of any of aspects 15 through 26.

Aspect 41: A non-transitory computer-readable medium storing code for wireless communications, the code comprising instructions executable by one or more processors to perform a method of any of aspects 15 through 26.

Aspect 42: A UE for wireless communications, comprising one or more memories storing processor-executable code, and one or more processors coupled with the one or more memories and individually or collectively operable to execute the code to cause the UE to perform a method of any of aspects 27 through 31.

Aspect 43: A UE for wireless communications, comprising at least one means for performing a method of any of aspects 27 through 31.

Aspect 44: A non-transitory computer-readable medium storing code for wireless communications, the code comprising instructions executable by one or more processors to perform a method of any of aspects 27 through 31.

Aspect 45: A network entity for wireless communications, comprising one or more memories storing processor-executable code, and one or more processors coupled with the one or more memories and individually or collectively operable to execute the code to cause the network entity to perform a method of any of aspects 32 through 35.

Aspect 46: A network entity for wireless communications, comprising at least one means for performing a method of any of aspects 32 through 35.

Aspect 47: A non-transitory computer-readable medium storing code for wireless communications, the code comprising instructions executable by one or more processors to perform a method of any of aspects 32 through 35.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), phase change memory, flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means e.g., A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a control message that indicates a first configuration for a plurality of connected mode discontinuous reception (CDRX) cycles of the UE;
transmit a response message that indicates a preferred configuration for the plurality of CDRX cycles or indicates a request to skip one or more first CDRX cycles of the plurality of CDRX cycles; and
monitor at least a subset of the plurality of CDRX cycles in accordance with the response message.

2. The UE of claim 1, wherein, to transmit the response message, the one or more processors are individually or collectively operable to execute the code to cause the UE to:
transmit a request message that indicates the preferred configuration for the plurality of CDRX cycles, and wherein monitoring at least the subset of the plurality of CDRX cycles comprises:
monitor the plurality of CDRX cycles in accordance with the preferred configuration based at least in part on the request message.

3. The UE of claim 2, wherein the one or more processors are individually or collectively further operable to execute the code to cause the UE to:
receive a second control message that indicates a plurality of configurations for the plurality of CDRX cycles, including at least the first configuration and the preferred configuration, and wherein the request message indicates the preferred configuration from the plurality of configurations.

4. The UE of claim 2, wherein the first configuration is associated with a set of values, and wherein the request message indicates the preferred configuration via one or more offsets from the set of values.

5. The UE of claim 2, wherein the one or more processors are individually or collectively further operable to execute the code to cause the UE to:
receive an acknowledgement message, responsive to the request message, that indicates the UE is to apply the preferred configuration, wherein the plurality of CDRX cycles are monitored in accordance with the preferred configuration based at least in part on the acknowledgement message.

6. The UE of claim 2, wherein the one or more processors are individually or collectively further operable to execute the code to cause the UE to:
receive a second control message, responsive to the request message, that indicates a second configuration for the plurality of CDRX cycles, wherein the second configuration is based at least in part on the preferred configuration, and wherein the plurality of CDRX cycles are monitored in accordance with the second configuration.

7. The UE of claim 1, wherein, to transmit the response message, the one or more processors are individually or collectively operable to execute the code to cause the UE to:
transmit the response message that indicates the request to skip the one or more first CDRX cycles of the plurality of CDRX cycles, wherein monitoring at least the subset of the plurality of CDRX cycles comprises:
monitor one or more second CDRX cycles of the plurality of CDRX cycles, wherein at least the subset of the plurality of CDRX cycles comprises the one or more second CDRX cycles and does not comprise the one or more first CDRX cycles.

8. The UE of claim 7, wherein the one or more processors are individually or collectively further operable to execute the code to cause the UE to:
skip monitoring of the one or more first CDRX cycles of the plurality of CDRX cycles based at least in part on transmitting the response message.

9. The UE of claim 7, wherein the one or more processors are individually or collectively further operable to execute the code to cause the UE to:
receive an acknowledgement message, responsive to the response message, that indicates the UE is to skip the one or more first CDRX cycles of the plurality of CDRX cycles, wherein the one or more second CDRX cycles of the plurality of CDRX cycles is monitored based at least in part on the acknowledgement message.

10. The UE of claim 1, wherein, to transmit the response message, the one or more processors are individually or collectively operable to execute the code to cause the UE to:
transmit the response message that indicates the UE is to skip monitoring for one or more first uplink control grants, one or more first downlink grants, or both, within the one or more first CDRX cycles, wherein monitoring at least the subset of the plurality of CDRX cycles comprises:
monitor for second uplink grants, second downlink grants, or both, within one or more second CDRX cycles based at least in part on the response message, wherein at least the subset of the plurality of CDRX cycles comprises the one or more second CDRX cycles and does not comprise the one or more first CDRX cycles.

11. The UE of claim 10, wherein the one or more processors are individually or collectively further operable to execute the code to cause the UE to:
skip monitoring for the one or more first uplink control grants, the one or more first downlink grants, or both, within the one or more first CDRX cycles based at least in part on the response message.

12. The UE of claim 11, wherein the one or more processors are individually or collectively further operable to execute the code to cause the UE to:
receive an acknowledgement message, responsive to the response message, that indicates the UE is to skip monitoring for the one or more first uplink control grants, the one or more first downlink grants, or both, within the one or more first CDRX cycles, wherein skipping monitoring for the one or more first uplink control grants, the one or more first downlink grants, or both, is based at least in part on receiving the acknowledgement message.

13. The UE of claim 10, wherein the response message indicates the UE is to skip monitoring of monitoring for the one or more first uplink control grants, the one or more first downlink grants, or both, within the one or more first CDRX cycles across one or more component carriers of a plurality of component carriers configured for the UE.

14. A network entity, comprising:
one or more memories storing processor-executable code; and
one or more processors coupled with the one or more memories and individually or collectively operable to execute the code to cause the network entity to:
transmit a control message that indicates a first configuration for a plurality of connected mode discontinuous reception (CDRX) cycles of a user equipment (UE);
receive a response message that indicates a preferred configuration of the UE for the plurality of CDRX cycles or indicates a request for the UE to skip one or more first CDRX cycles of the plurality of CDRX cycles; and
transmit one or more messages within at least a subset of the plurality of CDRX cycles in accordance with the response message.

15. The network entity of claim 14, wherein, to receive the response message, the one or more processors are individually or collectively operable to execute the code to cause the network entity to:
receive a request message that indicates the preferred configuration for the plurality of CDRX cycles, wherein transmitting the one or more messages within at least the subset of the plurality of CDRX cycles comprises:
transmit the one or more messages within the plurality of CDRX cycles in accordance with the preferred configuration based at least in part on the request message.

16. The network entity of claim 15, wherein the one or more processors are individually or collectively further operable to execute the code to cause the network entity to:
transmit a second control message that indicates a plurality of configurations for the plurality of CDRX cycles, including at least the first configuration and the preferred configuration, and wherein the request message indicates the preferred configuration from the plurality of configurations.

17. The network entity of claim 15, wherein the first configuration is associated with a set of values, and wherein the request message indicates the preferred configuration via one or more offsets from the set of values.

18. The network entity of claim 15, wherein the one or more processors are individually or collectively further operable to execute the code to cause the network entity to:
transmit an acknowledgement message, responsive to the request message, that indicates the UE is to apply the preferred configuration, wherein the plurality of CDRX cycles are monitored in accordance with the preferred configuration.

19. The network entity of claim 15, wherein the one or more processors are individually or collectively further operable to execute the code to cause the network entity to:
transmit a second control message, responsive to the request message, that indicates a second configuration for the plurality of CDRX cycles, wherein the second configuration is based at least in part on the preferred configuration, and wherein the plurality of CDRX cycles are monitored in accordance with the second configuration.

20. The network entity of claim 15, wherein, to receive the response message, the one or more processors are individually or collectively operable to execute the code to cause the network entity to:
receive the response message that indicates the request to skip the one or more first CDRX cycles of the plurality of CDRX cycles, wherein transmitting the one or more messages within at least the subset of the plurality of CDRX cycles comprises:
transmit the one or more messages within one or more second CDRX cycles of the plurality of CDRX cycles based at least in part on the response message, wherein at least the subset of the plurality of CDRX cycles comprises the one or more second CDRX cycles and does not comprise the one or more first CDRX cycles.

21. The network entity of claim 20, wherein the one or more processors are individually or collectively further operable to execute the code to cause the network entity to:
transmit an acknowledgement message, responsive to the response message, that indicates the UE is to skip the one or more first CDRX cycles of the plurality of CDRX cycles, wherein the one or more messages is transmitted within one or more second CDRX cycles of the plurality of CDRX cycles based at least in part on transmitting the acknowledgement message.

22. The network entity of claim 15, wherein, to receive the response message, the one or more processors are individually or collectively operable to execute the code to cause the network entity to:
receive the response message that indicates the UE is to skip monitoring for one or more first uplink control grants, one or more first downlink grants, or both, within the one or more first CDRX cycles, wherein transmitting the one or more messages within at least the subset of the plurality of CDRX cycles comprises:
transmit one or more second uplink grants, one or more second downlink grants, or both, within one or more second CDRX cycles based at least in part on the response message, wherein at least the subset of the plurality of CDRX cycles comprises the one or more second CDRX cycles and does not comprise the one or more first CDRX cycles, and wherein the one or more messages comprises the one or more second uplink grants, the one or more second downlink grants, or both.

23. The network entity of claim 22, wherein the one or more processors are individually or collectively further operable to execute the code to cause the network entity to:
transmit an acknowledgement message, responsive to the response message, that indicates the UE is to skip monitoring for the one or more first uplink control grants, the one or more first downlink grants, or both, within the one or more first CDRX cycles, wherein the one or more second uplink grants, the one or more second downlink grants, or both, is transmitted within one or more second CDRX cycles based at least in part on transmitting the acknowledgement message.

24. The network entity of claim 22, wherein the response message indicates the UE is to skip monitoring of monitoring for the one or more first uplink control grants, the one or more first downlink grants, or both, within the one or more first CDRX cycles across one or more component carriers of a plurality of component carriers configured for the UE.

25. A user equipment (UE), comprising:
one or more memories storing processor-executable code; and
one or more processors coupled with the one or more memories and individually or collectively operable to execute the code to cause the UE to:
receive a control message that indicates a configuration associated with a plurality of connected mode discontinuous reception (CDRX) cycles of the UE;
receive, prior to an active duration of a CDRX cycle of the plurality of CDRX cycles, a wake up signal that indicates one or more carriers, of a plurality of carriers configured for the UE, for which the UE is to monitor for control information within the active duration; and
monitor one or more control channels associated with the one or more carriers within the active duration of the CDRX cycle based at least in part on the wake up signal.

26. The UE of claim 25, wherein the one or more processors are individually or collectively further operable to execute the code to cause the UE to:
refrain from monitoring one or more second carriers, of a plurality of carriers configured for the UE, for control information within the active duration based at least in part on the wake up signal indicating the one or more carriers.

27. The UE of claim 25, wherein the wake up signal further indicates that one or more uplink grants, one or more downlink grants, or both, are to be transmitted within the active duration, and wherein the one or more control channels are monitored for the one or more uplink grants, the one or more downlink grants, or both, based at least in part on the wake up signal indicating the one or more uplink grants, the one or more downlink grants, or both, are to be transmitted.

28. The UE of claim 25, wherein the wake up signal further indicates a threshold rank to be scheduled within the active duration, and wherein monitoring the one or more control channels associated with the one or more carriers within the active duration of the CDRX cycle is based at least in part on the threshold rank.

29. A network entity, comprising:
one or more memories storing processor-executable code; and
one or more processors coupled with the one or more memories and individually or collectively operable to execute the code to cause the network entity to:
transmit a control message that indicates a configuration associated with a plurality of connected mode discontinuous reception (CDRX) cycles of a user equipment (UE);
transmit, prior to an active duration of a CDRX cycle of the plurality of CDRX cycles, a wake up signal that indicates one or more carriers, of a plurality of carriers configured for the UE, for which the UE is to monitor for control information within the active duration; and
transmit one or more messages via one or more control channels associated with the one or more carriers within the active duration of the CDRX cycle based at least in part on the wake up signal.

30. The network entity of claim 29, wherein the wake up signal further indicates that one or more uplink grants, one or more downlink grants, or both, are to be transmitted within the active duration, and wherein the one or more control channels are monitored for the one or more uplink grants, the one or more downlink grants, or both, based at least in part on the wake up signal indicating the one or more uplink grants, the one or more downlink grants, or both, are to be transmitted.
